(19) United States
(12) Patent Application Publication
(10) Pub. No.: US 2004/0011650 A1
(43) Pub. Date: Jan. 22, 2004

(54) Method and apparatus for manipulating polarizable analytes via dielectrophoresis

(76) Inventors: Frederic Zenhausern, Fountain Hills, AZ (US); Chia-Fu Chou, Chandler, AZ (US); Robert Henry Terbrueggen, Manhattan Beach, CA (US)

Correspondence Address: DORSEY & WHITNEY LLP, Four Embarcadero Center-Suite 3400, San Francisco, CA, 94111-4187, US

(21) Appl. No.: 10/201,613

(22) Filed: Jul. 22, 2002

(51) Int. Cl. G01N 27/27

(52) U.S. Cl. 204/547; 204/643

(57) ABSTRACT

The present invention is directed to devices and methods for manipulating polarizable analytes via dielectrophoresis to allow for improved detection of target analytes. Microfluidic devices are configured such that the application of a voltage between field-generating electrodes results in the generation of an asymmetric electric field within the device. Some embodiments of the invention provide a physical constriction, and electrically floating conductive material or a combination of the two techniques to generating an asymmetrical field. Using dielectrophoresis, target analytes are concentrated or separated from contaminant analytes and transported to a detection module.

### FIELD OF THE INVENTION

The invention relates to devices and methods for manipulating polarizable analytes via dielectrophoresis and detecting analytes, particularly analytes such as nucleic acids, and more particularly to a device and method suitable for trapping at least one polarizable analyte at a capture probe.

### BACKGROUND OF THE INVENTION

The solution concentration of target analyte species is one of the prime determinants of the time necessary to detect the target analyte in an assay. In practice, it can take several (tens of) hours for hybridization to be substantially complete at the low target nucleic acid levels available for biological samples. There is a need in the art for a device that enhances the concentration of a target analyte in such a way as to enhance the performance of a biosensor.

Controlled handling of individual biomolecules, or collective ordering, positioning, separation, alignment, sorting, accumulation or dispersion of multiple biomolecules on a single microfluidic device at the micron and sub-micron domain remains challenging.

Dielectrophoresis is the motion of particles caused by the effects of dielectric polarization in non-uniform electric fields. Unlike electrophoresis, where the force acting on a particle is determined by its net charge, the dielectrophoresis (DEP) force depends on the volume and dielectric properties of the particle. For a spherical particle of radius r, the DEP force, F_{DEP} is given by:

$${F}_{DEP} = 2 π {r}^{3} {ϵ}_{m} Re [ {f}_{CM} ] ∇ {E}^{2}$$

where εₘ is the absolute permittivity of the suspending medium, E is the local (rms) electromagnetic field, ∇ is the del vector operator and Re[f_{cm}] is the real part of the Clausium-Mossotti factor, defined as:

$${f}_{CM} = \frac{{ϵ}_{p}^{*} - {ϵ}_{m}^{*}}{{ϵ}_{p}^{*} + {ϵ}_{m}^{*}}$$

where εₚ* and εₘ* are the complex permittivities of the particle and medium respectively, as described in M. P. Hughes, et. al. Biochimica et Biophysica Acta 1425 (1998) 119-126, incorporated herein by reference. Depending on the permittivities of the particle and medium, then, the dielectrophoresis force may be positive (positive DEP), or negative (negative DEP).

Thus, when a dielectric particle is exposed to an electric field, it polarizes. The size and direction of the induced electric dipole depend on the frequency of the applied field and dielectric properties of the particle and medium, such as conductivity, permittivity, morphology and shape of the dielectric particle. Typically in an inhomogeneous field, this causes a force due to the interaction of the induced dipole and the electric field. Dielectric particles may also be moved in electromagnetic fields due to a gradient in the field phase (typically exploited in electrorotation and traveling wave dielectrophoresis), see for example Pohl H. A., J. Appl. Phys., 22, 869-871; Pohl, H. A., Dielectrophoresis, Cambridge University Press; Huang Y., R. C. Gascoyne et al., Biophysical Journal, 73, 1118-1129; Wang X. B., Gascoyne, R. C., Anal. Chem. 71, 911-918, 1999; and U.S. Pat. No. 5,858,192, all of which are hereby incorporated by reference.

Dielectrophoresis has been shown to be a powerful tool for the manipulation and separation of cells based on their dielectrophoresis response. See for example, S. Masuda, et. al., IEEE Trans. on Ind. Appl. 25(4) (1989), incorporated herein by reference. Masuda demonstrated that cells could be trapped at a constriction point in a channel. The cells could be subsequently fused with a voltage pulse. While the presence of the cells at the constriction point is sensed electronically, the detection is not specific to a certain cell or molecular type, nor does the cell specifically bind.

Cells have also been separated or categorized based on their dielectrophoresis response. See, for example, P. R. C. Gascoyne, et al., Meas. Sci. Technol. 3 (1992) 439-445, and G. Markx, et. al., J. of Biotechnology 32 (1994) 29-37, U.S. Pat. No. 6,071,394 (Nanogen), and U.S. Pat. No. 6,264,815, all incorporated herein by reference. Markx demonstrates separation of viable yeast cells from non-viable yeast cells based on the determination of a particular frequency at which the viable yeast cells experience positive DEP, while the non-viable cells experience negative DEP. Consequently, viable cells are drawn towards electrode edges and trapped there, while non-viable cells are attracted to the low field strength areas between electrodes, and can be washed away. Markx demonstrates similar cell separations in mammalian cells, while U.S. Pat. No. 6,071,394 demonstrates the separation of E. coli cells from blood cells. U.S. Pat. No. 6,264,815 discloses the use of a device employing dielectrophoresis forces to categorize and study the dielectrophoretic properties of cells. Viruses may similarly be manipulated via electrophoresis, see for example, M. P. Hughes, et. al. Biochimica et Biophysica Acta 1425 (1998) 119-126, hereby incorporated by reference.

Dielectrophoresis in combination with field flow fractionation has also been utilized to sort cells, see for example, J. Yang, et. al. Anal. Chem. 1999, 71, 911-918, U.S. Pat. No. 6,310,309, and U.S. Pat. No. 6,287,832, all incorporated herein by reference. These methods employ traveling wave electrophoresis combined with the hydrodynamic forces of the fluid flow to separate cells.

While dielectrophoresis has been demonstrated for the manipulation of cells and beads, etc. little work has been done on the manipulation of molecules, such as nucleic acids or proteins, via dielectrophoresis. This is in part due to the large field strengths necessary to generate a significant dielectrophoretic force on a molecule (recall the theoretical DEP force scaled with radius cubed).

Several methods have been demonstrated, however, by which to achieve the field strengths necessary to trap molecules, such as DNA. Several different approaches have been demonstrated including the positioning of a thin metallic wire between dielectrophoresis electrodes to magnify the field strength near the edge of the wire, or simply reducing the distance between the dielectrophoresis electrodes to the micron scale using high-resolution microfabrication techniques, see for example, C. Asbury, et. al. Biophysical Journal 74 (1998) 1024-1030 and U.S. Pat. No. 6,204,683. This approach restricts the area over which the dielectrophoresis is active.

There remains a need in this art for a device that provides the high electric field strengths necessary to manipulate biomolecules via dielectrophoresis over a large enough area such that the use of a biosensor is enhanced by the manipulations.

### SUMMARY OF THE INVENTION

The present invention provides methods and devices for manipulating polarizable analytes via dielectrophoresis and for detecting target analytes. An embodiment of the present invention is a microfluidic device comprising a concentration module in electronic communication with a field-generating electrode. The concentration module is configured to result in an asymmetrical, oscillating electric field within the concentration module upon application of a time-varying voltage. The device further comprises at least one detection module comprising capture probes and a power source. In an embodiment, the concentration module comprises at least one physical constriction to allow the generation of an asymmetrical field. In an embodiment, the detection module is placed at the physical constriction within the concentration module. In another embodiment, an electrically floating conductive material is present at the constriction. In an embodiment, the detection module comprises an array of detection electrodes each comprising a capture probe. In an embodiment, the detection electrodes further comprise a self-assembled monolayer.

An embodiment of a method according to the present invention is a method for detecting target analytes in a sample comprising contacting a concentration module with a sample. The concentration module is in a microfluidic device in electronic communication with at least two field-generating electrode. The method further comprises applying a time-varying voltage between said at least two field-generating electrodes sufficient to generate an asymmetrical electric field within the concentration module, thereby manipulating polarizable analytes in said sample via dielectrophoresis. After the sample is introduced and voltage applied, the target analytes are transported to a detection module under conditions sufficient for detection to occur. In an embodiment, manipulating comprises concentrating target analytes at said detection module, and the manipulating and transporting steps occur substantially simultaneously. In another embodiment, manipulating comprises concentrating target analytes and transporting comprises pumping sample containing said concentrated target analytes to said detection module. In another embodiment, manipulating comprises concentrating and trapping contamination analytes and transporting comprises pumping said sample containing said target analytes to said detection module. In another embodiment, manipulating comprises concentrating and trapping target analytes. In this embodiment, contamination analytes are washed from the concentration module, and transporting comprises pumping target analytes to the detection module. In another embodiment, the voltage between two field-generating electrodes is removed, the sample is agitated, and a time-varying voltage is again applied between at least two field-generating electrodes, thereby manipulating polarizable analytes via dielectrophoresis.

### BRIEF DESCRIPTION OF THE DRAWINGS

The accompanying drawings, which are schematic in nature and are incorporated in and form a part of this specification, illustrate several embodiments of the present invention or aspects of the present invention. Together with the description, the accompanying drawings serve to explain principles of the invention.

FIG. 1 is a schematic illustration of a variety of physical constrictions within channels according to the present invention.

FIG. 2 is a schematic illustration of a microfluidic device according to an embodiment of the present invention.

FIG. 3 is a top-down view of an electrode configuration according to an embodiment of the present invention.

FIG. 4 is a top-down view of electrode pair 501 in FIG. 3.

FIG. 5 is a schematic illustration of a microfluidic device according to an embodiment of the present invention.

FIG. 6 is a top-down view of a microfluidic device having programmable physical constrictions, according to an embodiment of the present invention.

### DETAILED DESCRIPTION OF THE INVENTION

The present invention is directed to devices and methods for manipulating polarizable analytes via dielectrophoresis to allow for improved detection of target analytes. Briefly, dielectrophoresis is the process by which polarizable particles are drawn toward an electric field maximum or minimum. Thus devices of the present invention are configured such that the application of a voltage between field-generating electrodes results in the generation of an asymmetric electric field, that is a field having at least one maximum or minimum, within the device. For example, some embodiments of the invention provide a physical constriction that gives asymmetry to the electric field. Other embodiments provide an electrically floating conductive material in the device that gives rise to an asymmetrical field. Still other embodiments employ a combination of these techniques.

Methods of the present invention are drawn toward manipulations ultimately resulting in improved detection of target analytes. Generally, target analytes are concentrated or separated from contaminant analytes and transported to a detection module. As further described below, the detection modules can be based on a variety of mechanisms, including, but not limited to, electronic, electrochemical, and optical detection. Some embodiments provide for concentrating target analytes at a detection module. Other embodiments provide for concentrating target analytes, then pumping them to a detection module. Still other embodiments provide for concentrating or retaining contaminant analytes and pumping target analytes to a detection area, e.g. removing contaminants. In some embodiments, the analytes are concentrated within a continuous flow as they are moved toward a detection area. In some embodiments, analytes are trapped via dielectrophoresis in a region despite surrounding fluid flow, for example by exerting a dielectrophoretic force on an analyte greater than the hydrodynamic force exerted on the analyte by fluid motion. Alternatively, analytes may be trapped via dielectrophoresis by attaching to one or more electrodes. Trapped analytes can then be manipulated in a variety of ways, for example being subjected to various agents, such as lysing agents or amplification agents.

Embodiments of the invention can be configured in a variety of ways to provide a variety of functionalities as is described below and referenced in the figures. For example, one embodiment of the present invention provides a set of interdigitated electrodes. Target analytes are transported to a powered electrode through electrophoresis, then transported to a detection electrode through dielectrophoresis. Another embodiment provides a method for performing nucleic acid amplification, such as PCR, for example when the target analyte is a nucleic acid.

Methods and devices provided by the present invention are directed toward detecting target analytes in a sample. As will be appreciated by those in the art, the sample solution may comprise any number of things, including, but not limited to, bodily fluids (including, but not limited to, blood, urine, serum, lymph, saliva, anal and vaginal secretions, perspiration and semen; and solid tissues, including liver, spleen, bone marrow, lung, muscle, brain, etc.) of virtually any organism, with mammalian samples being preferred and human samples being particularly preferred); environmental samples (including, but not limited to, air, agricultural, water and soil samples); biological warfare agent samples; research samples (i.e. in the case of nucleic acids, the sample may be the products of an amplification reaction, including both target and signal amplification as is generally described in PCT/US99/01705, such as PCR or SDA amplification reactions); purified samples, such as purified genomic DNA, RNA, proteins, etc.; raw samples (bacteria, virus, genomic DNA, etc.; As will be appreciated by those in the art, virtually any experimental manipulation may have been done on the sample.

The present invention provides microfluidic devices for manipulating polarizable analytes via dielectrophoresis. By “polarizable analyte” herein is meant any analyte forming an electromagnetic dipole upon exposure to a sufficient electric field. By “analyte” or grammatical equivalents herein is meant any molecule, compound, specie or particle to be manipulated. A further distinction is made between “target analytes” and “contamination analytes”. As used herein, “target analyte” is used to refer to analytes to be detected or quantified. As used herein, “contamination analyte” is used to refer to analytes present in a sample that are not to be detected. These “contamination analytes” frequently interfere with the efficient detection of “target analytes”. As outlined below, target analytes preferably bind to binding ligands, as is more fully described below. As will be appreciated by those in the art, a large number of analytes may be manipulated and subsequently detected using the present methods; basically, any polarizable target analyte for which a binding ligand, described herein, may be made may be detected using the methods of the invention.

Suitable analytes include organic and inorganic molecules, including biomolecules. In a preferred embodiment, the analyte may be an environmental pollutant (including pesticides, insecticides, toxins, etc.); a chemical (including solvents, polymers, organic materials, etc.); therapeutic molecules (including therapeutic and abused drugs, antibiotics, etc.); biomolecules (including hormones, cytokines, proteins, lipids, carbohydrates, cellular membrane antigens and receptors (neural, hormonal, nutrient, and cell surface receptors) or their ligands, etc); whole cells (including procaryotic (such as pathogenic bacteria) and eukaryotic cells, including mammalian tumor cells); nuclei; viruses (including retroviruses, herpesviruses, adenoviruses, lentiviruses, etc.); and spores; etc. Particularly preferred analytes are environmental pollutants; nucleic acids; proteins (including enzymes, antibodies, antigens, growth factors, cytokines, etc); therapeutic and abused drugs; cells; and viruses.

In a preferred embodiment, the analyte is a nucleic acid. By “nucleic acid” or “oligonucleotide” or grammatical equivalents herein means at least two nucleotides covalently linked together. A nucleic acid of the present invention will generally contain phosphodiester bonds, although in some cases, as outlined below, nucleic acid analogs are included that may have alternate backbones, comprising, for example, phosphoramide (Beaucage et al., Tetrahedron 49(10):1925 (1993) and references therein; Letsinger, J. Org. Chem. 35:3800 (1970); Sprinzl et al., Eur. J. Biochem. 81:579 (1977); Letsinger et al., Nucl. Acids Res. 14:3487 (1986); Sawai et al, Chem. Lett. 805 (1984), Letsinger et al., J. Am. Chem. Soc. 110:4470 (1988); and Pauwels et al., Chemica Scripta 26:141 91986)), phosphorothioate (Mag et al., Nucleic Acids Res. 19:1437 (1991); and U.S. Pat. No. 5,644,048), phosphorodithioate (Briu et al., J. Am. Chem. Soc. 111:2321 (1989), O-methylphophoroamidite linkages (see Eckstein, Oligonucleotides and Analogues: A Practical Approach, Oxford University Press), and peptide nucleic acid backbones and linkages (see Egholm, J. Am. Chem. Soc. 114:1895 (1992); Meier et al., Chem. Int. Ed. Engl. 31:1008 (1992); Nielsen, Nature, 365:566 (1993); Carlsson et al., Nature 380:207 (1996), all of which are incorporated by reference). Other analog nucleic acids include those with positive backbones (Denpcy et al., Proc. Natl. Acad. Sci. USA 92:6097 (1995); non-ionic backbones (U.S. Pat. Nos. 5,386,023, 5,637,684, 5,602,240, 5,216,141 and 4,469,863; Kiedrowshi et al., Angew. Chem. Intl. Ed. English 30:423 (1991); Letsinger et al., J. Am. Chem. Soc. 110:4470 (1988); Letsinger et al., Nucleoside & Nucleotide 13:1597 (1994); Chapters 2 and 3, ASC Symposium Series 580, “Carbohydrate Modifications in Antisense Research”, Ed. Y. S. Sanghui and P. Dan Cook; Mesmaeker et al., Bioorganic & Medicinal Chem. Lett. 4:395 (1994); Jeffs et al., J. Biomolecular NMR 34:17 (1994); Tetrahedron Lett. 37:743 (1996)) and non-ribose backbones, including those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Nucleic acids containing one or more carbocyclic sugars are also included within the definition of nucleic acids (see Jenkins et al., Chem. Soc. Rev. (1995) pp169-176). Several nucleic acid analogs are described in Rawls, C & E News Jun. 2, 1997 page 35. Nucleic acid analogs also include “locked nucleic acids”. All of these references are hereby expressly incorporated by reference. These modifications of the ribose-phosphate backbone may be done to facilitate the addition of labels, etc., or to increase the stability and half-life of such molecules in physiological environments.

As will be appreciated by those in the art, all of these nucleic acid analogs may find use in the present invention. In addition, mixtures of naturally occurring nucleic acids and analogs can be made. Alternatively, mixtures of different nucleic acid analogs, and mixtures of naturally occurring nucleic acids and analogs may be made.

As outlined herein, the nucleic acids may be single stranded or double stranded, as specified, or contain portions of both double stranded or single stranded sequence. The nucleic acid may be DNA, both genomic and cDNA, RNA or a hybrid, where the nucleic acid contains any combination of deoxyribo- and ribo-nucleotides, and any combination of bases, including uracil, adenine, thymine, cytosine, guanine, inosine, xathanine hypoxathanine, isocytosine, isoguanine, etc. As used herein, the term “nucleoside” includes nucleotides and nucleoside and nucleotide analogs, and modified nucleosides such as amino modified nucleosides. In addition, “nucleoside” includes non-naturally occurring analog structures. Thus for example the individual units of a peptide nucleic acid, each containing a base, are referred to herein as nucleosides.

In a preferred embodiment, the present invention provides methods of manipulating and detecting target nucleic acids. By “target nucleic acid” or “target sequence” or grammatical equivalents herein means a nucleic acid sequence, generally on a single strand of nucleic acid. The target sequence may be a portion of a gene, a regulatory sequence, genomic DNA, cDNA, RNA including mRNA and rRNA, or others. It may be any length, with the understanding that longer sequences are more specific. In some embodiments, it may be desirable to fragment or cleave the sample nucleic acid into fragments of for example 100 to 10,000 basepairs, with fragments of roughly 500 basepairs being preferred in some embodiments. As will be appreciated by those in the art, the complementary target sequence may take many forms. For example, it may be contained within a larger nucleic acid sequence, i.e. all or part of a gene or mRNA, a restriction fragment of a plasmid or genomic DNA, among others.

As is outlined more fully below, probes (including primers) are made to hybridize to target sequences to determine the presence or absence of the target sequence in a sample. Generally speaking, this term will be understood by those skilled in the art.

The target sequence may also be comprised of different target domains, which may be adjacent (i.e. contiguous) or separated. For example, when oligonucleotide ligation amplification (OLA) reaction techniques are used, a first probe or primer may hybridize to a first target domain and a second primer may hybridize to a second target domain; either the domains are adjacent, or they may be separated by one or more nucleotides. The terms “first” and “second” are not meant to confer an orientation of the sequences with respect to the 5′-3′ orientation of the target sequence. For example, assuming a 5′-3′ orientation of the complementary target sequence, the first target domain may be located either 5′ to the second domain, or 3′ to the second domain.

In a preferred embodiment, the analyte is a protein. As will be appreciated by those in the art, there are a large number of possible proteinaceous target analytes that may be detected using the present invention. By “proteins” or grammatical equivalents herein is meant proteins, oligopeptides and peptides, derivatives and analogs, including proteins containing non-naturally occurring amino acids and amino acid analogs, and peptidomimetic structures. The side chains may be in either the ®) or the (S) configuration. In a preferred embodiment, the amino acids are in the (S) or L-configuration. As discussed below, when the protein is used as a binding ligand, it may be desirable to utilize protein analogs to retard degradation by sample contaminants. Further, proteins may be in various structural configurations such as helix, β sheets, linear and any other forms known in the art, occurring naturally or by synthesis.

Suitable protein analytes include, but are not limited to, (1) immunoglobulins, particularly IgEs, IgGs and IgMs, and particularly therapeutically or diagnostically relevant antibodies, including but not limited to, for example, antibodies to human albumin, apolipoproteins (including apolipoprotein E), human chorionic gonadotropin, cortisol, α-fetoprotein, thyroxin, thyroid stimulating hormone (TSH), antithrombin, antibodies to pharmaceuticals (including antieptileptic drugs (phenytoin, primidone, carbariezepin, ethosuximide, valproic acid, and phenobarbitol), cardioactive drugs (digoxin, lidocaine, procainamide, and disopyramide), bronchodilators (theophylline), antibiotics (chloramphenicol, sulfonamides), antidepressants, immunosuppresants, abused drugs (amphetamine, methamphetamine, cannabinoids, cocaine and opiates) and antibodies to any number of viruses (including orthomyxoviruses (e.g. influenza virus), paramyxoviruses (e.g respiratory syncytial virus, parainfluenza virus, mumps virus, measles virus), astroviruses, adenoviruses, coronaviruses, reoviruses (e.g. rotaviruses), togaviruses (e.g. rubella virus), parvoviruses (e.g. erythroviruses), poxyiruses (e.g. variola virus, vaccinia virus), hepatitis viruses (including A, B, C, D (deltaviruses), and E), herpesviruses (e.g. herpes simplex virus, varicella-zoster virus, cytomegalovirus, Epstein-Barr virus), caliciviruses (e.g. Norwalk viruses), arenaviruses, rhabdovirus (e.g. rabies virus), retroviruses (including HIV, HTLV-I and -II), papovaviruses (e.g. papillomaviruses, polyomaviruses), picornaviruses (e.g. enteroviruses (e.g. poliovirus, coxsackievirus), cardioviruses, rhinoviruses, aphthoviruses (e.g. foot-and-mouth disease virus), and hepatoviruses), flaviviruses (e.g. West Nile virus), bunyaviruses (e.g. hantaviruses), filoviruses (e.g. Ebola virus) and the like); bacteria (including a wide variety of pathogenic and non-pathogenic prokaryotes of interest including Bacillus, e.g. B. anthracis; Vibrio, e.g. V. cholerae; Escherichia, e.g. Enterotoxigenic E. coli; Shigella, e.g. S. dysenteriae; Salmonella, e.g. S. typhi; Mycobacterium, e.g. M. tuberculosis, M. leprae; Clostridium, e.g. C. botulinum, C. tetani, C. difficile, C. peffringens; Cornyebacterium, e.g. C. diphtheriae; Streptococcus, e.g. S. pyogenes, S. pneumoniae; Staphylococcus, e.g. S. aureus; Haemophilus, e.g. H. influenzae, Neisseria, e.g. N. meningitidis, N. gonorrhoeae; Yersinia. e.g. Y. enterocolitica, Y. pseudotuberculosis, Y. pestis, Pseudomonas, e.g. P. aeruginosa, P. putida; Chlamydia, e.g. C. trachomatis; Bordetella, B. pertussis; Treponema, e.g. T. palladium; fungi and yeast (e.g. C. neoformans) and the like, and parasites (e.g. protozoa (e.g. G. lamblia, E. histolytica) and the like); (2) enzymes (and other proteins), including but not limited to, enzymes used as indicators of or treatment for heart disease, including creatine kinase, lactate dehydrogenase, aspartate amino transferase, troponin T, myoglobin, fibrinogen thrombin, tissue plasminogen activator (tPA); pancreatic disease indicators including amylase, lipase, chymotrypsin and trypsin; liver function enzymes and proteins including cholinesterase, bilirubin, and alkaline phosphotase; aldolase, prostatic acid phosphatase, terminal deoxynucleotidyl transferase, and bacterial and viral enzymes such as reverse transcriptase and HIV protease; (3) hormones and cytokines (many of which serve as ligands for cellular receptors) such as erythropoietin (EPO), thrombopoietin (TPO), the interleukins (including IL-1 through IL-17), insulin, insulin-like growth factors (including IGF-1 and -2), epidermal growth factor (EGF), transforming growth factors (including TGF-α and TGF-β), human growth hormone, transferrin, epidermal growth factor (EGF), low density lipoprotein, high density lipoprotein, leptin, VEGF, PDGF, ciliary neurotrophic factor, prolactin, adrenocorticotropic hormone (ACTH), calcitonin, human chorionic gonadotropin, cotrisol, estradiol, follicle stimulating hormone (FSH), thyroid-stimulating hormone (TSH), leutinzing hormone (LH), progeterone and testosterone; and (4) lipids such as cholesterol, triglycerides, steroids and the like.

In addition, any of the biomolecules for which antibodies may be detected may be detected directly as well; that is, detection of virus or bacterial cells, therapeutic and abused drugs, etc., may be done directly.

Suitable analytes include carbohydrates, including but not limited to, markers for breast cancer (CA15-3, CA 549, CA 27.29), mucin-like carcinoma associated antigen (MCA), ovarian cancer (CA125), pancreatic cancer (DE-PAN-2), prostate cancer (PSA), CEA, and colorectal and pancreatic cancer (CA 19, CA 50, CA242).

In a preferred embodiment, electrolyte solutions are preferably used in the methods of the invention. In the practice of the invention, a capture probes are exposed to an electrolyte solution containing a target molecule for a time and under conditions sufficient for the target to bind to a probe.

Electrolyte solutions useful in the apparatus and methods of the invention include but are not limited to any electrolyte solution at physiologically-relevant ionic strength (equivalent to about 0.15M NaCl) and neutral pH. Non-limiting examples of electrolyte solutions useful with the apparatus and methods of the invention include but are not limited to phosphate buffered saline, HEPES buffered solutions, and sodium bicarbonate buffered solutions. In alternative embodiments useful for electrical detection methods provided by the invention, the electrolyte solution comprises metal cations or polymerized cations that are ion conductive and capable of reacting with probes or probe-target complexes.

The present invention provides microfluidic devices for manipulating polarizable analytes via dielectrophoresis and, preferably, for subsequent detection of target analytes. By ‘microfluidic devices’ herein is meant a device suitable for handling small amounts of fluid, generally nanoliters, although in some applications a larger or smaller fluid volume will be necessary. Structures within such microfluidic devices generally have dimensions on the order of microns, although in many cases larger dimensions on the order of millimeters, or smaller dimensions on the order of nanometers, are advantageous.

As will be appreciated by those in the art, the microfluidic devices of the present invention may be fabricated in a variety of ways and may be substantially composed of a variety of materials. A variety of suitable materials, methods and configurations are described in WO 00/62931, WO 01/54813 and PCT US99/23324, all of which are expressly incorporated by reference herein in their entirety.

As is known in the art, microfluidic devices are generally constructed substantially of a substrate. The substrate can be made of a wide variety of materials and can be configured in a large number of ways, as is discussed herein and will be apparent to one of skill in the art. The composition of the substrate will depend on a variety of factors, including the techniques used to create the device, the use of the device, the composition of the sample, the analyte to be detected, the size of internal structures, the presence or absence of electronic components, and the technique used to move fluid, etc. Generally, the devices of the invention should be easily sterilizable as well, although in some applications this is not required. The devices could be disposable or re-usable, preferably after a cleaning procedure. Such a cleaning procedure could be implemented using, for example, an internal or embedded heater, a gas plasma or other radiation source.

In a preferred embodiment, the substrate can be made from a wide variety of materials including, but not limited to, silicon such as silicon wafers, silicon dioxide, silicon nitride, glass and fused silica, gallium arsenide, indium phosphide, III-V materials, PDMS, silicone rubber, aluminum, ceramics, polyimide, quartz, plastics, resins and polymers including polymethylmethacrylate, acrylics, polyethylene, polyethylene terepthalate, polycarbonate, polystyrene and other styrene copolymers, polypropylene, polytetrafluoroethylene, superalloys, zircaloy, steel, gold, silver, copper, tungsten, molybdeumn, tantalum, KOVAR, KEVLAR, KAPTON, MYLAR, teflon, brass, sapphire, etc. High quality glasses such as high melting borosilicate or fused silicas may be preferred for their UV transmission properties when any of the sample manipulation steps require light based technologies. In addition, as outlined herein, portions of the internal surfaces of the device may be coated with a variety of coatings as needed, to reduce non-specific binding, to allow the attachment of binding ligands, for biocompatibility, for flow resistance, etc.

Microfluidic devices of the present invention may be fabricated using a variety of techniques, including, but not limited to, hot embossing, such as described in H. Becker, et al., Sensors and Materials, 11, 297, (1999), hereby incorporated by reference, molding of elastomers, such as described in D. C. Duffy, et. al., Anal. Chem., 70, 4974, (1998), hereby incorporated by reference, injection molding, LIGA, soft lithography, SFIL, silicon fabrication and related thin film processing techniques, circuit board fabrication technology, and in a preferred embodiment, the microfluidic devices are fabricated using ceramic multilayer fabrication techniques, such as are outlined in U.S. Ser. Nos. 09/235,081; 09/337,086; 09/464,490; 09/492,013; 09/466,325; 09/460,281; 09/460,283; 09/387,691; 09/438,600; 09/506,178; and 09/458,534; all of which are expressly incorporated by reference in their entirety. In this embodiment, the devices are made from layers of green-sheet that have been laminated and sintered together to form a substantially monolithic structure.

Microfluidic devices of the present invention may contain a variety of structures for containing fluid, either stationary fluid or flowing fluid. These structures fall generally into two categories, referred to herein as chambers and channels. By ‘chamber’, herein is meant a space or volume that is capable of containing a volume of fluid. In some embodiments, chambers are provided for the storage of agents or samples. In some embodiments, chambers are provided allowing sample fluid to contact an electrode, a physical constriction, or a detection module, as described further below. A chamber can be any shape, for example it may be square, rectangular, cylindrical, or the like. It may connect with other chambers. Chambers may be closed and completely internal to the device, or may be open to some degree to allow the introduction of sample. The volume of a chamber can vary depending on the fluid it is designed to contain and the application. In general, chamber sizes range from 1 nL to about 1 mL, with from about 1 to about 250 μL being preferred and from about 10 to about 100 μL being especially preferred.

By ‘channel’, or ‘microchannel’, herein is meant a space capable of containing a volume of fluid within the device. Generally, ‘channel’ or ‘microchannel’ refers to a region designed to have fluid moved through it, substantially from one end of the channel to another. In some embodiments, channels are designed to allow fluid to come into contact with an electrode, a physical constriction or a detection module, as described further below. A channel may have any shape, for example, it may be linear, serpentine, arc shaped and the like. The cross-sectional dimension of the channel may be square, rectangular, semicircular, circular, etc. Additionally, the cross-sectional dimension of the channel may change across its length. Channels may be closed and completely internal to the device, or they may be substantially open to accommodate the introduction or removal of sample or agents. The channels have preferred depths on the order of 0.1 μm to 100 μm, typically 2-50 μm. The channels have preferred widths on the order of 2.0 to 500 μm, more preferably 3-100 μm. For many applications, channels of 5-50 μm are useful. In one embodiment, a channel with a 200 μm cross-section is provided. In other embodiments, nanochannels, having cross-sectional dimensions on the order of nanometers may be provided. There may be multiple and interconnected channels. In one embodiment of the present invention, channels in one orientation intersect at multiple locations with channels having an orthogonal orientation.

Microfluidic devices comprising chambers and channels may be fabricated in a variety of ways depending on the size, orientation and intended use of the channels and chambers as well as their material composition. Briefly, channels or chambers, may be fabricated in the substrate material by selectively removing portions of the substrate material in any manner known in the art, the substrate material having been discussed above. Alternatively, channels are fabricated out of a material layer deposited on or otherwise supported by the substrate. In this manner, structures, such as electronics, found on the substrate remain accessible to the fluid channels. Chambers or channels may be sealed by a further material layer that is bonded or otherwise adhered to the material layer comprising the channel. The sealing layer may cover all or a portion of the channel or chamber. In other embodiments, channels and chambers may be fabricated using sacrificial layers, where a sacrificial material having the desired size and shape of the channel or chamber is defined on the substrate, coated with a desired material that will form the channel or chamber walls. Selective removal of the sacrificial material leaves a channel or chamber within the device. In still further embodiments, channels and chambers are formed during a molding process. In preferred embodiments of the present invention, channels are fabricated from insulating materials. In one embodiment of the present invention, channels are fabricated from SU-8 photoresist atop a silicon substrate comprising a layer of silicon dioxide and silicon nitride. In other embodiments, channels are fabricated in PDMS. In another embodiment of the present invention, channels are fabricated from solidified magnetorheological fluid supported by a substrate material, as described further below.

In a preferred embodiment, chambers, channels, or the substrate of the microfluidic device are made from, or coated with, biocompatible materials in regions where they will come into contact with biological samples. In particular, materials that provide a surface that retards the non-specific binding of biomolecules, e.g. a “non sticky” surface, are preferred. For example, when a chamber is used for PCR or amplification reactions a “non sticky” surface prevents enzymatic components of the reaction mixture from sticking to the surface and being unavailable in the reaction.

Biocompatible materials are well known in the art and include, but are not limited to, plastic (including acrylics, polystyrene and copolymers of styrene and other materials, polypropylene, polyethylene, polybutylene, polyimide, polycarbonate, polyurethanes, Teflon™, and derivatives thereof, etc.) Other configurations include combinations of plastic and printed circuit board (PCB; defined below). For example at least one side of a chamber is printed circuit board, while one or more sides of a chamber are made from plastic. In a preferred embodiment, three sides of a chamber are made from plastic and one side is made from printed circuit board. In addition, the chambers, channels, and other components of the systems described herein may be coated with a variety of materials to reduce non-specific binding. These include proteins such as caseins and albumins (bovine serum albumin, human serum albumin, etc.), parylene, other polymers, etc.

Accordingly, microfluidic devices of the present invention may be configured in a large variety of ways to perform a wide array of applications. Generally, then microfluidic devices of the present invention contain one or more “modules”. By “module”, herein is meant a component or organization of components that enables a certain functionality in the microfluidic device. Modules may be independent and utilized sequentially. Modules may be independent and in fluidic communication with one another by, for example, microchannels. One or more modules may be substantially integrated with one another in the microfluidic device. Examples of a variety of preferred modules are presented below.

The present invention provides microfluidic devices for manipulating polarizable analytes via dielectrophoresis. Briefly, dielectrophoresis is the process by which polarizable particles are drawn toward an electric field maximum or minimum. Unlike electrophoresis, where the force acting on a particle is determined by its net charge, the dielectrophoresis (DEP) force depends on the volume and dielectric properties of the particle. C. F. Chou, et. al., Biophys. J., in press, 2002. Depending on the relative complex permittivies of the analyte and the sample medium, the target analyte will either be attracted (positive DEP) or repulsed (negative DEP) from the electric field maximum. Some target analytes will experience either positive DEP or negative DEP in the same medium depending on the frequency of the applied electric field. Thus, requirements for manipulating analytes via dielectrophoresis include generating an oscillating, asymmetrical electric field of sufficient strength and frequency to manipulate the chosen analyte.

Accordingly, the present invention provides microfluidic devices comprising at least one concentration module. As is further outlined below, the concentration module includes dielectrophoretic concentration modules, as well as other types of concentration modules, as are further outlined below.

Thus, in this context, by ‘concentration module’ herein is meant a module designed to manipulate polarizable analytes via dielectrophoresis. The concentration module provided by the invention is accordingly in electronic communication with at least one field-generating electrode. By “field-generating electrodes” herein is meant conductive electrodes connected to a power source provided for the purpose of generating a non-uniform electric field within a sample to facilitate manipulation of target analytes via dielectrophoresis. Field-generating electrodes generally may be composed of a variety of conductive materials including aluminum, platinum, copper, silver, tungsten, gold, titanium, conductive plastic, and metal impregnated polymers. A voltage is applied to a field generating electrode or between two or more field-generating electrodes to generate a sufficient electric field within the sample for dielectrophoresis to occur. The necessary electric field strength will vary according to the chosen analyte, the desired manipulation, and the particular device used. In a preferred embodiment, the target analyte is a nucleic acid and electric field strengths of about 10⁵ to about 10⁷ V/m are preferred, with a strength of about 10⁶ particularly preferred. Field-generating electrodes are generally placed within the channel along the direction of desired dielectrophoretic motion. However, field-generating electrodes may be external to the provided microfluidic device, or may be in any orientation associated with the channel. There may be multiple field-generating electrodes for generating electric fields in a variety of directions, or sequentially subjecting a sample to varying electric fields. Field-generating electrodes may be coated with a permeating layer to prevent damage to target analytes that come into contact with the electrodes. The permeation layer may be composed of passivating oxide layers, polymer materials or any biocompatible material as is known in the art.

Field-generating electrodes may take any shape. In some embodiments, simple square or rectangular electrodes are provided. Electrodes may have dimensions large enough, for example on the order of millimeters, to be contacted with external probes. In other embodiments, strip-type electrodes may be used, and placed at any distance from one another. Other embodiments employ interdigitated electrodes having any number of fingers. Through microfabrication techniques, these fingers, or the strip-type electrodes may be placed with minimal spacing to increase the field strength between fingers or strips. In other embodiments, field-generating electrodes comprise variegated edges for the purpose of generating an electric field having a maximum strength at a location along the edge. Electrodes may be fabricated from the deposition of conductive material or from thick film pastes. The field-generating electrodes need not all be of the same form. Any one of the electrodes may be chosen from the group described here, and any of the others chosen or designed to generate an electric field pattern of choice. Alternatively, field-generating electrodes may be external to the device, and may be placed on or near the microfluidic device to generate an electric field within it.

The present invention provides microfluidic devices comprising a concentration module in electrical communication with at least one field-generating electrode, wherein the concentration module is configured to result in generation of an asymmetrical, preferably oscillating electric field within the module upon application of a time-varying voltage to the electrode or electrodes. By ‘in electrical communication’ herein is meant that the application of a voltage to the field-generating electrodes results in the generation of an electrical field within the microfluidic device. By “asymmetrical, oscillating electric field”, herein is meant an oscillating electric field having at least one maximum or minimum within the module, such that a polarizable analyte in a sample contained in the module feels at least a dielectrophoresis force.

By “oscillating” electric field, herein is meant a time-varying electric field such that a polarizable analyte is attracted toward one electrode for a certain time period and attracted toward another electrode during another time period, or in a different direction. Generally, an oscillating electric field is generated by applying an time-varying voltage between two electrodes. The voltage waveform between the two electrodes may take a variety of forms. It may be a sine wave, a square wave, a sawtooth wave, or substantially any other periodic waveform. Generally, the waveform will be centered around a ground potential, but may be biased around any voltage—that is, a DC bias or offset may be used. The voltage difference is typically achieved by holding one electrode at a ground potential and applying a time-varying voltage to one or more other electrodes. However, the voltage difference may also be achieved by simultaneously powering multiple electrodes or powering a single electrode. The frequency, or periodicity, of the voltage difference, and hence the electric field, may vary and is chosen based on the application and the analyte of interest as well as the module geometry and sample composition. Preferred frequencies are between 1 Hz and 1 Ghz, with about 100 Hz-500 kHz being particularly preferred, however the frequency chosen is dependent on the sample and analytes of interest.

Accordingly, the present invention provides microfluidic devices comprising a power source, capable of generating the time-varying voltages discussed above. The power source provides a voltage sufficient to generate the field strengths necessary, as discussed above. The voltage needed depends on the field strength needed, the geometry of the electrodes, the composition of electrodes and sample. Generally, a peak-to-peak voltage between 1 V and 1 kV is preferred. The power source can be associated with other power electronics or power conditioning devices, including for example power amplifiers.

By “asymmetric electric field” herein is meant an electric field within a module having at least one maximum or minimum. While the electric field may in fact comprise a symmetrical pattern within the device, herein “asymmetric electric field” is used to denote asymmetry from the perspective of an analyte within the device. That is, an analyte experiences a stronger or weaker electric field in one direction than another. The asymmetry may be achieved in a variety of ways. In some embodiments, an insulated physical constriction is provided within the concentration module to give asymmetry to the electric fields. In other embodiments, an electrically floating conductive material is placed between field-generating electrodes to enhance the asymmetry of the field. In still other embodiments, the geometry of the field-generating electrodes themselves, as discussed above, gives rise to an asymmetrical field. In yet other embodiments, a combination of these techniques is employed.

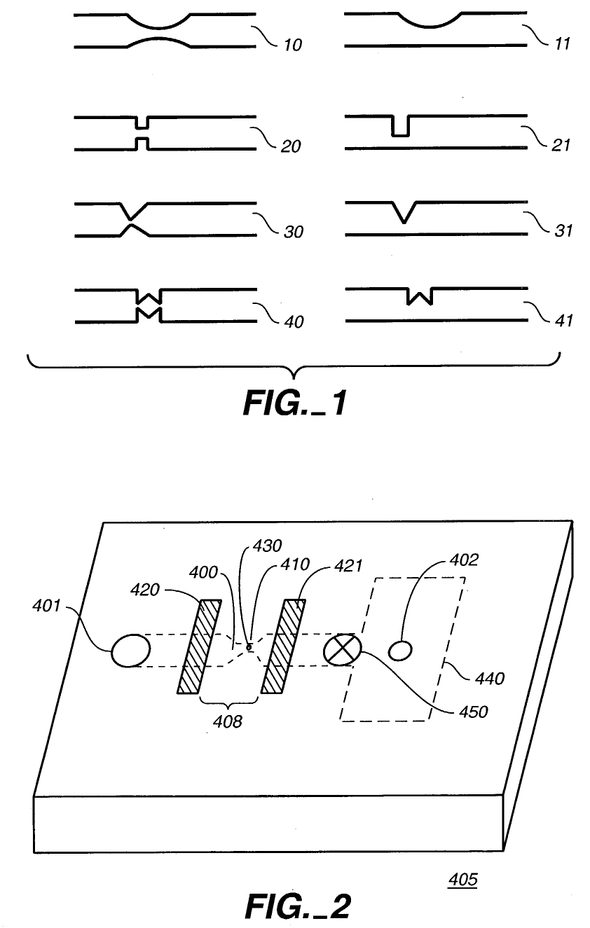

Accordingly, some embodiments of the present invention provide microfluidic devices comprising a concentration module comprising a physical constriction. By “physical constriction” herein is meant generally an area of the concentration module having a substantially smaller width for fluidic passage than the remainder of the module. FIG. 1 depicts a top-down view of a variety of physical constrictions within channels. Channels 10, 20 and 30 depict two-sided physical constrictions. Channels 11, 21, and 31 illustrate one-sided constrictions. Channel 10 contains a physical constriction with bowing sidewalls, only one sidewall is bowed in channel 11. Channel 20 contains a physical constriction where both sidewalls abruptly protrude into the channel; only one sidewall protrudes into the channel 21. Channel 30 contains a physical constriction that is most severe in one location, as the sidewalls come to a point as they protrude into the channel; only one sidewall comes to a point as it protrudes into channel 31. Channel 40 comprises two constriction points in series, with both sidewalls protruding inwards twice. Channel 41 comprises an analogous one-sided constriction. The channel narrowing may occur gradually as in channels, or abruptly as in channels. Preferably, the physical constriction is fabricated from a dielectric or preferably an insulating material. Such a physical constriction facilitates a substantially increased electric field within the constriction compared to the remainder of the module. The physical constriction may be one-sided or two-sided. The constriction may be sharp or gradual. The constriction may occur at one or multiple locations. The constriction may comprise an angled wall, where the angle is chosen according to the desired function and the particular polarizable analyte used. The physical constriction point may be along the direction of fluid flow, and therefore also constrict any fluid flow through the device. In one embodiment, a portion of a microchannel has a substantially decreased width from the remainder of the channel. For example, in one embodiment, a 200 μm channel is provided that gradually narrows at one location to a constriction area having a width of 4 μm. Alternatively, or in addition, physical constrictions may be provided that are not in the direction of fluid flow. In another embodiment, multiple openings that serve as constriction points are provided along one wall of a microchannel. In one embodiment, these openings also provide access to orthogonally-oriented channels.

A variety of techniques can be utilized to fabricate channels with an insulating physical constriction point. In one embodiment, photolithography techniques are used to fabricate the physical constriction, and the dimensions of the constriction are therefore fixed. In another embodiment, solidified magnetorheological fluid may be used to form the channel and physical constriction with the capability to create an addressable, movable array of constrictions within a microfluidic channel. In this embodiment, the constriction dimensions are ‘programmable’ based on the configuration of electromagnetic circuitry beneath the channel.

Still other embodiments of the present invention provide microfluidic devices comprising a concentration module comprising an electrically floating conductive material. By “electrically floating” herein is meant material that is not driven to any particular potential, but is allowed to assume a voltage as dictated by its environment. Electrically floating materials are generally made of the same materials as electrodes. Electric field lines terminate on conductive surfaces, and this provides for a stronger electric field at the edges. This technique is described in Asbury, C. L. et al, “Trapping of DNA in non-uniform oscillating electric field, Biophys. J., 74, 1024-30, 1998, incorporated herein by reference. In one embodiment, electrically floating electrodes are interleaved with field-generating electrodes to create an asymmetrical field. In another embodiment, electrically floating conductive material is placed in or near a physical constriction to further enhance the asymmetry of the electric field there.

“Microfluidic device” as used herein also is intended to include the use of one or more of a variety of components, herein referred to as “modules”, that will be present on any given device depending on its use. These modules include, but are not limited to: sample inlet ports; sample introduction or collection modules; cell handling modules (for example, for cell lysis, cell removal, cell separation or capture, cell growth, etc.); separation modules, for example, for electrophoresis, gel filtration, ion exchange/affinity chromatography (capture and release) etc.; reaction modules for chemical or biological alteration of the sample, including amplification of the target analyte (for example, when the target analyte is nucleic acid, amplification techniques are useful, including, but not limited to polymerase chain reaction (PCR), ligase chain reaction (LCR), strand displacement amplification (SDA), and nucleic acid sequence based amplification (NASBA)), chemical, physical or enzymatic cleavage or alteration of the target analyte, or chemical modification of the target; fluid pumps; fluid valves; thermal modules for heating and cooling (which may be part of other modules, such as reaction modules); storage modules for assay reagents; mixing chambers; and detection modules.

In a preferred embodiment, the devices of the invention include at least one fluid pump. Pumps generally fall into two categories: “on chip” and “off chip”; that is, the pumps (generally electrode based pumps) can be contained within the device itself, or they can be contained on an apparatus into which the device fits, such that alignment occurs of the required flow channels to allow pumping of fluids.

In a preferred embodiment, the pumps are contained on the device itself. These pumps are generally electrode based pumps; that is, the application of electric fields can be used to move both charged particles and bulk solvent, depending on the composition of the sample and of the device. Suitable on chip pumps include, but are not limited to, electroosmotic (EO) pumps, electrohydrodynamic (EHD) pumps, and magneto-hydrodynamic (MHD) pumps; these electrode based pumps have sometimes been referred to in the art as “electrokinetic (EK) pumps”. All of these pumps rely on configurations of electrodes placed along a flow channel to result in the pumping of the fluids comprising the sample components. As is described in the art, the configurations for each of these electrode based pumps are slightly different; for example, the effectiveness of an EHD pump depends on the spacing between the two electrodes, with the closer together they are, the smaller the voltage required to be applied to effect fluid flow. Alternatively, for EO pumps, the spacing between the electrodes should be larger, with up to one-half the length of the channel in which fluids are being moved, since the electrodes are only involved in applying force, and not, as in EHD, in creating charges on which the force will act.

In a preferred embodiment, an electroosmotic pump is used. Electroosmosis (EO) is based on the fact that the surface of many solids, including quartz, glass and others, become variously charged, negatively or positively, in the presence of ionic materials. The charged surfaces will attract oppositely charged counterions in aqueous solutions. Applying a voltage results in a migration of the counterions to the oppositely charged electrode, and moves the bulk of the fluid as well. The volume flow rate is proportional to the current, and the volume flow generated in the fluid is also proportional to the applied voltage. Electroosmostic flow is useful for liquids having some conductivity is and generally not applicable for non-polar solvents. EO pumps are described in U.S. Pat. Nos. 4,908,112 and 5,632,876, PCT US95/14586 and WO97/43629, incorporated by reference.

In a preferred embodiment, an electrohydrodynamic (EHD) pump is used. In EHD, electrodes in contact with the fluid transfer charge when a voltage is applied. This charge transfer occurs either by transfer or removal of an electron to or from the fluid, such that liquid flow occurs in the direction from the charging electrode to the oppositely charged electrode. EHD pumps can be used to pump resistive fluids such as non-polar solvents. EHD pumps are described in U.S. Pat. No. 5,632,876, hereby incorporated by reference.

The electrodes of the pumps preferably have a diameter from about 25 microns to about 100 microns, more preferably from about 50 microns to about 75 microns. Preferably, the electrodes protrude from the top of a flow channel to a depth of from about 5% to about 95% of the depth of the channel, with from about 25% to about 50% being preferred. In addition, as described in PCT US95/14586, an electrode-based internal pumping system can be integrated into the liquid distribution system of the devices of the invention with flow-rate control at multiple pump sites and with fewer complex electronics if the pumps are operated by applying pulsed voltages across the electrodes; this gives the additional advantage of ease of integration into high density systems, reductions in the amount of electrolysis that occurs at electrodes, reductions in thermal convection near the electrodes, and the ability to use simpler drivers, and the ability to use both simple and complex pulse wave geometries.

The voltages required to be applied to the electrodes cause fluid flow depends on the geometry of the electrodes and the properties of the fluids to be moved. The flow rate of the fluids is a function of the amplitude of the applied voltage between electrode, the electrode geometry and the fluid properties, which can be easily determined for each fluid. Test voltages used may be up to about 1500 volts, but an operating voltage of about 40 to 300 volts is desirable. An analog driver is generally used to vary the voltage applied to the pump from a DC power source. A transfer function for each fluid is determined experimentally as that applied voltage that produces the desired flow or fluid pressure to the fluid being moved in the channel. However, an analog driver is generally required for each pump along the channel and is suitable an operational amplifier.

In a preferred embodiment, a micromechanical pump is used, either on- or off-chip, as is known in the art.

In a preferred embodiment, an “off-chip” pump is used. For example, the devices of the invention may fit into an apparatus or appliance that has a nesting site for holding the device, that can register the ports (i.e. sample inlet ports, fluid inlet ports, and waste outlet ports) and electrode leads. The apparatus can include pumps that can apply the sample to the device; for example, can force cell-containing samples into cell lysis modules containing protrusions, to cause cell lysis upon application of sufficient flow pressure. Such pumps are well known in the art.

In a preferred embodiment, on- or off-chip pressure-driven pumps are used. For example, an “air pump” can be used to move fluid. In this embodiment, a chamber of air is incorporated in a device having a heater. When the heater is turned on, the air in the chamber expands according to PV=nRT. Preferably, heaters (as are also described below) are incorporated into the middle of the chip. In some embodiments, more than one heater is incorporated in a chip to create “heater zones”. Air chambers or pockets are located over the heater zones. The air chambers are connected to the reaction chamber via a channel that runs up to the top of the reaction chamber with a valve or a plug blocking it off. When the air is heated, it expands. The resulting build up in pressure forces the valve or plug to move out of the way, thereby forcing the liquid out of the chamber.

Other ways of moving fluid include using a low boiling liquid in place of air. In this embodiment, the low boiling liquid expands when heated and displaces the liquid contained in a chamber. Alternatively, a chemical reaction may be used to move liquid out of a chamber. For example, the chemical reaction used to expand car air bags may be used to move liquid out of the reaction chamber, or other reactions in which gases are generated.

Other types of pressure-based pumps that can be used include syringe driven pumps. These pumps can be actuated either by expanding air behind the syringe or by mechanical means. For example, TiNi alloys, nitinol wire, or “shape memory metals” can be used to mechanically actuate a syringe driven pump. By “TiNi alloys”, “nitinol wire” or “shape memory metals” herein is meant materials that when heated above a certain transition temperature contract (i.e., usually up to 3 to 5% over the original length of the metal), thereby changing shape. Other materials that change shape upon heating include shape memory plastics.

Pumps also may be created using spring loaded pistons. In this embodiment, a spring that can be released is compressed or restrained within the body of the cartridge. For example, wax may be used to hold a spring in its compressed state. Upon heating, the wax is melted, and the spring is released, thereby generating sufficient force to move a piston and displace liquid. Other versions include incorporating materials that change from solids to liquids at a given transition temperature, or moving a mechanical blockade from the spring's pathway.

Pumps that utilize PZT driven actuations are also known and may be incorporated in this invention. By “PZT” herein is meant a material comprised of lead, zirconium and titanium which upon application of a voltage undergoes a rearrangement of the crystal lattice and generates a force and a displacement. This so called piezoelectric effect can be used to constrict and expand a pump chamber and result in a net movement of liquid. Other materials like shape memory alloys that under a change in shape upon application of a current such that the temperature of the metal is raised above a certain transition temperature can also be used.

In a preferred embodiment, one or more pumps are used to transport target analytes to a detection module. In another embodiment, one or more pumps are used to contact a module with a sample or an agent, as described below. In other embodiments, pumps are used to agitate a sample or wash contaminant analytes from a concentration module, as described below.

In a preferred embodiment, one or more pumps are used to recirculate the sample within the channels of the device, to allow for increased binding of the target analyte to the capture binding ligand.

In a preferred embodiment, the devices of the invention include at least one fluid valve that can control the flow of fluid into or out of a module of the device, or divert the flow into one or more channels. A variety of valves are known in the art. For example, in one embodiment, the valve may comprise a capillary barrier, as generally described in PCT US97/07880, incorporated by reference. In this embodiment, the channel opens into a larger space designed to favor the formation of an energy minimizing liquid surface such as a meniscus at the opening. Preferably, capillary barriers include a dam that raises the vertical height of the channel immediately before the opening into a larger space such a chamber. In addition, as described in U.S. Pat. No. 5,858,195, incorporated herein by reference, a type of “virtual valve” can be used.

In a preferred embodiment, a chamber in the microfluidic device has one or more valves controlling the flow of fluids into and out of the chamber. The number of valves in the cartridge depends on the number of channels and chambers, and the desired application. Alternatively, the microfluidic device is designed to include one or more loading ports or valves that can be closed off or sealed after the sample is loaded. It is also possible to have multiple loading ports into a single chamber; for example, a first port is used to load sample and a second port is used to add reagents. In these embodiments, the microfluidic device may have a vent. The vent can be configured in a variety of ways. In some embodiments, the vent can be a separate port, optionally with a valve, that leads out of the reaction chamber. Alternatively, the vent may be a loop structure that vents liquid and/or air back into the inlet port.

As will be appreciated by those in the art, a variety of different valves may be used. Valves can be multi cycle or single cycle valves. By “multicycle” valves is meant that the valve can be opened and closed more than once. By “single cycle valves” or “burst valves” or “one time valves” herein is meant a valve that is closed and then opened or opened and then closed but lacks a mechanism for restoring the valve to its original position. Valves may also be check valves, which allow fluid flow in only one direction, or bi-directional valves.

In a preferred embodiment, check valves are used to prevent fluid from going in and out of the reaction chamber during reactions. Generally check valves are used in embodiments where it is desirable to have fluids and/or air flow in one direction, but not the other. For example, when the chamber is filled and thus compressed, air and liquid flow out. Conversely, valves can be used to empty the chamber as well. Types of check valves that can be used include, but are not limited to, duck bill valves (Vernay, www.vernay.com), cantilevers, bubble valves, etc.

In a preferred embodiment, the valve is a cantilever valve. As will be appreciated by those in the art, there are a variety of different types of cantilever valves known in the art. Cantilever valves can also be configured for use in pumping systems as described below. In a preferred embodiment, a cantilever valve comprising a metal is used. In this embodiment, the application of a voltage can either open or close a valve.

In a preferred embodiment, a heat pump is incorporated into the system for opening and closing the cantilever valve. In this embodiment, the check valves are made out of metals such as gold and copper such that the check valve functions as a cantilever when heat is applied. In other embodiments, an actuating force is not used to pull down the valve, rather they have a restraining force that prevents them from going in the other direction.

Similarly, a “thermally actuated” valve that comprises a portion of the microchannel with a flexible membrane filled with air or liquid can be used in conjunction with a heater. The application of heat causes the fluid to expand, blocking the channel.

In other embodiments, piezoelectric (PZT) mixers are used as valves. These can be built out of silicon (obtained from Frauhoffer), plastic (obtained from IMM) or PCB.

Other materials can be used in combination with check valves include materials that can be used to block an inlet or an outlet port. Such materials include wax or other polymeric materials, such as poly(ethylene oxide)-poly(propylene oxide)-poly(ethylene oxide) triblock copolymers (PEO-PPO-PEO) known commercially as Pluronics (BASF; Pluronic F-127, Sigma) or Synperonic (ICI), that melt for use as membranes or plugs. These materials share the common feature that they can go from a solid to a liquid at a given temperature. These types of systems are used in conjunction with heaters, described below. For example, heat is applied to melt the material, thus “opening” the valve.

In a preferred embodiment, the burst valve is a film of metal or polymer. In a preferred embodiment, a free standing gold film is used, that is constructed using standard techniques as outlined herein, by etching away a support surface. The gold membrane dissolves upon application of a voltage and Cl⁻ ions. See for example www.mchips.com; Santini, J. T., et al., 1999, Nature, 397:335-338; both of which are incorporated by reference in their entirety.

In a preferred embodiment, a combination of check valves and wax plugs are used. In other embodiments, a combination of check valves and gold membranes are used.

Other means of making a valve include mechanical means. These can frequently be bi-directional valves. For example, a shape memory wire can be attached to a plunger blocking a channel. By applying a current to the wire, the wire contracts and moves the plunger out of the way, thereby opening the channel. Conversely, the plunger can be drawn into the channel to block the channel.

Other mechanical valves include rotary valves. Rotary valves can be configured in a variety of ways. In one embodiment, an external force must be applied for rotation (i.e., a screw driver or stepper motor). Alternatively, a shape memory wire can be used, such that the application of heat or current will shrink the wire to rotate the valve. A complete description of these, and other valves and pumps described above, can be found in WO 01/54813 and PCT US 01/44364, hereby incorporated by reference.

In addition, commercially available valves may be used in to control the flow of liquids from into and out of the various chambers of the present invention. Examples of commercially available valves include, MEMS (micro-electro-mechanical systems) micro valves (www.redwoodmicro.com), TiNi liquid microvalve (TiNi Alloy Company, San Leandro, Calif.), TiNi pneumatic microvalves (TiNi Alloy Company, San Leandro, Calif.), silicon micro valves (Bosch, D., et al., Sensors and Actuators A, 37-38 (1993) 684-692). Commercial/conventional valves also are available from Measurement Specialities, Inc., IC Sensors Division, Milpitas, Calif. (www.msiusa.com/icsensors); Plast-O-Matic Valves, Inc. (www.plastomatic.com), Barworth Inc. (www.barworthinc.com), Mobile Electronics Solution (www.mobileelectronics.net); Specrum Chromatograph (www.lplc.com); all of which are hereby incorporated by reference in their entirety.

Microfluidic devices of the present invention may include a variety of ports, such as inlet or outlet ports, or vents. “Inlet and outlet port” as used herein refers to one or more openings in a microfluidic device suitable for introducing a sample or other fluid into a channel, or removing a sample, waste, or other fluid from the channel. “Vent”, as discussed above, generally refers to an opening in a microfluidic device, or a chamber of the device, for pressure equalization. In one embodiment, the ports are designed for use with conventional pipettes. In another embodiment, multiple inlet ports are provided for the introduction of a variety of fluids, including lysing agents, amplification agents, or sample fluid containing target analytes.

Ports may optionally comprise a seal to prevent or reduce the evaporation of the sample or agents from a chamber. In a preferred embodiment, the seal comprises a gasket, or valve through which a pipette or syringe can be pushed. The gasket or valve can be rubber or silicone or other suitable materials, such as materials containing cellulose.

In another embodiment, the microfluidic device comprises channels or chambers that are substantially open. For example, a chamber or channel having rectangular cross-section may have only three walls. In this embodiment, then, the “inlet port” is the top of the device itself, and may subsequently be sealed with another material comprising the fourth wall of the chamber or channel, or another material, such as mineral oil.

“Microfluidic device” as used herein is further meant to include devices using one or more component to influence or monitor the temperature of a sample, referred to generally as a ‘thermal module’. For example, heaters, including thin-film resistive heating elements, may be provided on- or off-chip. Similarly, coolers, such as heat sinks or heat exchange conduits, may be provided on- or off-chip. Temperature monitoring devices may similarly be incorporated on- or off-chip and are known in the art. The composition and design of heaters, coolers, and temperature monitors will be dictated by the application and the material composition of the microfluidic device.

In one embodiment, heaters, coolers, and temperature monitors are provided to achieve thermal cycling of a chamber to perform PCR.

Suitable thermal modules are described in U.S. Pat. Nos. 5,498,392 and 5,587,128, and WO 97/16561, incorporated by reference, and may comprise electrical resistance heaters, pulsed lasers or other sources of electromagnetic energy directed to the microfluidic device. It should also be noted that when heating elements are used, it may be desirable to have a chamber be relatively shallow, to facilitate heat transfer; see U.S. Pat. No. 5,587,128.

When the devices of the invention include thermal modules, preferred embodiments utilize microfluidic devices having chambers or channels fabricated to have low thermal conductivity in order to minimize thermal crosstalk between adjacent chambers on the microchip, which permits independent thermal control of each chamber or channel.

In certain embodiments, the temperature of a chamber or channel is increased using a thermal module comprising an integrated heater. In preferred embodiments, the integrated heater is a resistive heater, and more preferably a thick film resistive heater plate. Alternatively, chambers or channels can be heated through the use of metal lines integrated beneath the well or surrounding sides of the chambers or channels, more preferably in a coil having one or more loops, in vertical or horizontal orientation. Parallel, variable heating of individual chambers or channels in a microchip array may be accomplished through the use of addressing schemes, preferably a column-and-row or individual electrical addressing scheme, in order to independently control the heat output of the resistive heaters in the vicinity of each chamber or channel.

In certain embodiments, the temperature of the chambers or channels is decreased using a thermal module comprising an integrated cooler. In preferred embodiments, the integrated cooler is a metal via at the bottom of each chamber or channel. In further preferred embodiments, the integrated cooler is a thermo-electric cooler attached to or integrated into the microchip beneath each chamber or channel. Optionally, a metal via is in thermal contact with a metal plate, an array of metal discs or a thermo-electric cooler, each of which functions as a heat sink or an active cooling means. Commercially-available thermo-electric coolers can also be incorporated into the inventive apparatus, because they can be obtained in a wide range of dimensions, including components of a size required for the fabrication of the microfluidic devices of the present invention. In embodiments comprising metal heat sinks encompassing a metal plate or an array of metal discs, the plate or discs are composed of iron, aluminum, or other suitable metal. Parallel, variable cooling of individual chambers or channels in a microfluidic device may be accomplished through the use of addressing schemes, preferably a column-and-row or individual electrical addressing scheme, in order to independently control heat dissipation using cooling elements in the vicinity of each chamber or channel.

In preferred embodiments of the microfluidic devices of the invention, the thermal module includes temperature monitors, to monitor the temperature of the chamber or channel using an integrated resistive thermal detector or a thermocouple. This can be incorporated into the substrate or added later, and is in thermal contact and proximity to the chamber or channel structures of the microfluidic devices of the invention. The resistive thermal detector can be fabricated from a commercially available paste that can be processed in a customized manner for any given design. Such thermocouples are commercially available in sizes of at least 250 microns, including the sheath. In certain alternative embodiments, the temperature of the chambers or channels is monitored using an integrated optical system, for example, an infrared-based system. In other embodiments, one or more p-n diodes are used as temperature sensors.

In a preferred embodiment, the devices of the invention include a cell handling module. This is of particular use when the sample comprises cells that either contain the target analyte or that must be removed in order to detect the target analyte. Thus, for example, the detection of particular antibodies in blood can require the removal of the blood cells for efficient analysis, or the cells (and/or nucleus) must be lysed prior to detection. In this context, “cells” include eukaryotic and prokaryotic cells, and viral particles that may require treatment prior to analysis, such as the release of nucleic acid from a viral particle prior to detection of target sequences. In addition, cell handling modules may also utilize a downstream means for determining the presence or absence of cells. Suitable cell handling modules include, but are not limited to, cell lysis modules, cell removal modules, and cell separation or capture modules. In addition, as for all the modules of the invention, the cell handling module may be integrated with other modules, or independent and in fluid communication, or capable of being brought into communication, via a channel with at least one other module of the invention.

In a preferred embodiment, the cell handling module includes a cell lysis module. As is known in the art, cells may be lysed in a variety of ways, depending on the cell type. In one embodiment, as described in EP 0 637 998 B1 and U.S. Pat. No. 5,635,358, hereby incorporated by reference, the cell lysis module may comprise cell membrane piercing protrusions that extend from a surface of the cell handling module. As fluid is forced through the device, the cells are ruptured. Similarly, this may be accomplished using sharp edged particles trapped within the cell handling region. Alternatively, the cell lysis module can comprise a region of restricted cross-sectional dimension, which results in cell lysis upon pressure. In a preferred embodiment, the cell lysis module comprises a concentration module, described above, that concentrates and traps the cells in a physical constriction. As the cells are trapped at the physical constriction, lysing agent is applied to the area of the physical constriction, causing lysing. In another preferred embodiment, localized heating causes cell lysing as the cells are trapped at a physical constriction, or other area of maximum or minimum electric field strength.

In a preferred embodiment, the cell lysis module comprises a cell lysing agent, such as guanidium chloride, chaotropic salts, enzymes such as lysozymes, etc. In some embodiments, for example for blood cells, a simple dilution with water or buffer can result in hypotonic lysis. The lysis agent may be solution form, stored within the cell lysis module or in a storage module and pumped into the lysis module. Alternatively, the lysis agent may be in solid form, that is taken up in solution upon introduction of the sample.

In another preferred embodiment, cells are manipulated via dielectrophoresis, as described above, and are transported to a lysis module for subsequent lysing.

The cell lysis module may also include, either internally or externally, a filtering module for the removal of cellular debris as needed. This filter may be microfabricated between the cell lysis module and the subsequent module to enable the removal of the lysed cell membrane and other cellular debris components; examples of suitable filters are shown in EP 0 637 998 B1, incorporated by reference.

In a preferred embodiment, the cell handling module includes a cell separation or capture module. This embodiment utilizes a cell capture region comprising binding sites capable of reversibly binding a cell surface molecule to enable the selective isolation (or removal) of a particular type of cell from the sample population, for example, white blood cells for the analysis of chromosomal nucleic acid, or subsets of white blood cells. These binding moieties may be immobilized either on the surface of the module or on a particle trapped within the module (i.e. a bead) by physical absorption or by covalent attachment. Suitable binding moieties will depend on the cell type to be isolated or removed, and generally includes antibodies and other binding ligands, such as ligands for cell surface receptors, etc. Thus, a particular cell type may be removed from a sample prior to further handling, or the assay is designed to specifically bind the desired cell type, wash away the non-desirable cell types, followed by either release of the bound cells by the addition of reagents or solvents, physical removal (i.e. higher flow rates or pressures), or even in situ lysis.

Alternatively, a cellular “sieve” can be used to separate cells on the basis of size. This can be done in a variety of ways, including protrusions from the surface that allow size exclusion, a series of narrowing channels, a weir, or a diafiltration type setup.

In a preferred embodiment, the cell handling module includes a cell removal module. This may be used when the sample contains cells that are not required in the assay or are undesirable. Generally, cell removal will be done on the basis of size exclusion as for “sieving”, above, with channels exiting the cell handling module that are too small for the cells.

In a preferred embodiment, the cell handling module includes a cell concentration module. As will be appreciated by those in the art, this is done using “sieving” methods, for example to concentrate the cells from a large volume of sample fluid prior to lysis.

In a preferred embodiment, the devices of the invention include a separation module. Separation in this context means that at least one component of the sample is separated from other components of the sample. This can comprise the separation or isolation of the target analyte, or the removal of contaminants that interfere with the analysis of the target analyte, depending on the assay.

In a preferred embodiment, the separation module includes chromatographic-type separation media such as absorptive phase materials, including, but not limited to reverse phase materials (e.g. C₈ or C₁₈ coated particles, etc.), ion-exchange materials, affinity chromatography materials such as binding ligands, etc. See U.S. Pat. No. 5,770,029, herein incorporated by reference.

In a preferred embodiment, the separation module utilizes binding ligands, as is generally outlined herein for cell separation or analyte detection. In this embodiment, binding ligands are immobilized (again, either by physical absorption or covalent attachment, described below) within the separation module (again, either on the internal surface of the module, on a particle such as a bead, filament or capillary trapped within the module, for example through the use of a frit). Suitable binding moieties will depend on the sample component to be isolated or removed. By “binding ligand” or grammatical equivalents herein is meant a compound that is used to bind a component of the sample, either a contaminant (for removal) or the target analyte (for enrichment). In some embodiments, as outlined below, the binding ligand is used to probe for the presence of the target analyte, and that will bind to the analyte.

In a preferred embodiment, the separation module includes an electrophoresis module, as is generally described in U.S. Pat. Nos. 5,770,029; 5,126,022; 5,631,337; 5,569,364; 5,750,015, and 5,135,627, all of which are hereby incorporated by reference. In electrophoresis, molecules are primarily separated by different electrophoretic mobilities caused by their different molecular size, shape and/or charge. Microcapillary tubes have recently been used for use in microcapillary gel electrophoresis (high performance capillary electrophoresis (HPCE)). One advantage of HPCE is that the heat resulting from the applied electric field is efficiently dissipated due to the high surface area, thus allowing fast separation. The electrophoresis module serves to separate sample components by the application of an electric field, with the movement of the sample components being due either to their charge or, depending on the surface chemistry of the microchannel, bulk fluid flow as a result of electroosmotic flow (EOF).

As will be appreciated by those in the art, the electrophoresis module can take on a variety of forms, and generally comprises an electrophoretic microchannel and associated electrodes to apply an electric field to the electrophoretic microchannel. Waste fluid outlets and fluid reservoirs are present as required.

The electrodes comprise pairs of electrodes, either a single pair, or, as described in U.S. Pat. Nos. 5,126,022 and 5,750,015, a plurality of pairs. Single pairs generally have one electrode at each end of the electrophoretic pathway. Multiple electrode pairs may be used to precisely control the movement of sample components, such that the sample components may be continuously subjected to a plurality of electric fields either simultaneously or sequentially.

In a preferred embodiment, electrophoretic gel media may also be used. By varying the pore size of the media, employing two or more gel media of different porosity, and/or providing a pore size gradient, separation of sample components can be maximized. Gel media for separation based on size are known, and include, but are not limited to, polyacrylamide and agarose. One preferred electrophoretic separation matrix is described in U.S. Pat. No. 5,135,627, hereby incorporated by reference, that describes the use of “mosaic matrix”, formed by polymerizing a dispersion of microdomains (“dispersoids”) and a polymeric matrix. This allows enhanced separation of target analytes, particularly nucleic acids. Similarly, U.S. Pat. No. 5,569,364, hereby incorporated by reference, describes separation media for electrophoresis comprising submicron to above-micron sized cross-linked gel particles that find use in microfluidic systems. U.S. Pat. No. 5,631,337, hereby incorporated by reference, describes the use of thermoreversible hydrogels comprising polyacrylamide backbones with N-substituents that serve to provide hydrogen bonding groups for improved electrophoretic separation. See also U.S. Pat. Nos. 5,061,336 and 5,071,531, directed to methods of casting gels in capillary tubes.

In a preferred embodiment, the devices of the invention include a reaction module. This can include either physical, chemical or biological alteration of one or more sample components. Alternatively, it may include a reaction module wherein the target analyte alters a second moiety that can then be detected; for example, if the target analyte is an enzyme, the reaction chamber may comprise an enzyme substrate that upon modification by the target analyte, can then be detected. In this embodiment, the reaction module may contain the necessary reagents, or they may be stored in a storage module and pumped as outlined herein to the reaction module as needed.

In a preferred embodiment, the reaction module includes a chamber for the chemical modification of all or part of the sample. For example, chemical cleavage of sample components (CNBr cleavage of proteins, etc.) or chemical cross-linking can be done. PCT US97/07880, hereby incorporated by reference, lists a large number of possible chemical reactions that can be done in the devices of the invention, including amide formation, acylation, alkylation, reductive amination, Mitsunobu, Diels Alder and Mannich reactions, Suzuki and Stille coupling, chemical labeling, etc. Similarly, U.S. Pat. Nos. 5,616,464 and 5,767,259 describe a variation of LCR that utilizes a “chemical ligation” of sorts. In this embodiment, similar to LCR, a pair of primers are utilized, wherein the first primer is substantially complementary to a first domain of the target and the second primer is substantially complementary to an adjacent second domain of the target (although, as for LCR, if a “gap” exists, a polymerase and dNTPs may be added to “fill in” the gap). Each primer has a portion that acts as a “side chain” that does not bind the target sequence and acts as one half of a stem structure that interacts non-covalently through hydrogen bonding, salt bridges, van der Waal's forces, etc. Preferred embodiments utilize substantially complementary nucleic acids as the side chains. Thus, upon hybridization of the primers to the target sequence, the side chains of the primers are brought into spatial proximity, and, if the side chains comprise nucleic acids as well, can also form side chain hybridization complexes. At least one of the side chains of the primers comprises an activatable cross-linking agent, generally covalently attached to the side chain, that upon activation, results in a chemical cross-link or chemical ligation. The activatible group may comprise any moiety that will allow cross-linking of the side chains, and include groups activated chemically, photonically and thermally, with photoactivatable groups being preferred. In some embodiments a single activatable group on one of the side chains is enough to result in cross-linking via interaction to a functional group on the other side chain; in alternate embodiments, activatable groups are required on each side chain. In addition, the reaction chamber may contain chemical moieties for the protection or deprotection of certain functional groups, such as thiols or amines.

In a preferred embodiment, the reaction module includes a chamber for the biological alteration of all or part of the sample. For example, enzymatic processes including nucleic acid amplification, hydrolysis of sample components or the hydrolysis of substrates by a target enzyme, the addition or removal of detectable labels, the addition or removal of phosphate groups, etc.

In a preferred embodiment, the target analyte is a nucleic acid and the biological reaction chamber allows amplification of the target nucleic acid. Suitable amplification techniques include, both target amplification and probe amplification, including, but not limited to, polymerase chain reaction (PCR), ligase chain reaction (LCR), strand displacement amplification (SDA), self-sustained sequence replication (3SR), QB replicase amplification (QBR), repair chain reaction (RCR), cycling probe technology or reaction (CPT or CPR), and nucleic acid sequence based amplification (NASBA). In this embodiment, the reaction reagents generally comprise at least one enzyme (generally polymerase), primers, and nucleoside triphosphates as needed.

General techniques for nucleic acid amplification are discussed below. In most cases, double stranded target nucleic acids are denatured to render them single stranded so as to permit hybridization of the primers and other probes of the invention. A preferred embodiment utilizes a thermal step, generally by raising the temperature of the reaction to about 95° C., although pH changes and other techniques such as the use of extra probes or nucleic acid binding proteins may also be used. Thus, as more fully described above, the reaction chambers of the invention can include thermal modules.

A probe nucleic acid (also referred to herein as a primer nucleic acid) is then contacted to the target sequence to form a hybridization complex. By “primer nucleic acid” herein is meant a probe nucleic acid that will hybridize to some portion, i.e. a domain, of the target sequence. Probes of the present invention are designed to be complementary to a target sequence (either the target sequence of the sample or to other probe sequences, as is described below), such that hybridization of the target sequence and the probes of the present invention occurs. As outlined below, this complementarity need not be perfect; there may be any number of base pair mismatches which will interfere with hybridization between the target sequence and the single stranded nucleic acids of the present invention. However, if the number of mutations is so great that no hybridization can occur under even the least stringent of hybridization conditions, the sequence is not a complementary target sequence. Thus, by “substantially complementary” herein is meant that the probes are sufficiently complementary to the target sequences to hybridize under normal reaction conditions.

A variety of hybridization conditions may be used in the present invention, including high, moderate and low stringency conditions; see for example Maniatis et al., Molecular Cloning: A Laboratory Manual, 2d Edition, 1989, and Short Protocols in Molecular Biology, ed. Ausubel, et al, hereby incorporated by reference. Stringent conditions are sequence-dependent and will be different in different circumstances. Longer sequences hybridize specifically at higher temperatures. An extensive guide to the hybridization of nucleic acids is found in Tijssen, Techniques in Biochemistry and Molecular Biology—Hybridization with Nucleic Acid Probes, “Overview of principles of hybridization and the strategy of nucleic acid assays” (1993). Generally, stringent conditions are selected to be about 5-10° C. lower than the thermal melting point (Tm) for the specific sequence at a defined ionic strength pH. The Tm is the temperature (under defined ionic strength, pH and nucleic acid concentration) at which 50% of the probes complementary to the target hybridize to the target sequence at equilibrium (as the target sequences are present in excess, at Tm, 50% of the probes are occupied at equilibrium). Stringent conditions will be those in which the salt concentration is less than about 1.0 sodium ion, typically about 0.01 to 1.0 M sodium ion concentration (or other salts) at pH 7.0 to 8.3 and the temperature is at least about 30° C. for short probes (e.g. 10 to 50 nucleotides) and at least about 60° C. for long probes (e.g. greater than 50 nucleotides). Stringent conditions may also be achieved with the addition of destabilizing agents such as formamide. The hybridization conditions may also vary when a non-ionic backbone, i.e. PNA is used, as is known in the art. In addition, cross-linking agents may be added after target binding to cross-link, i.e. covalently attach, the two strands of the hybridization complex.

Thus, the assays are generally run under stringency conditions which allows formation of the hybridization complex only in the presence of target. Stringency can be controlled by altering a step parameter that is a thermodynamic variable, including, but not limited to, temperature, formamide concentration, salt concentration, chaotropic salt concentration pH, organic solvent concentration, etc.

These parameters may also be used to control non-specific binding, as is generally outlined in U.S. Pat. No. 5,681,697. Thus it may be desirable to perform certain steps at higher stringency conditions to reduce non-specific binding.

The size of the primer nucleic acid may vary, as will be appreciated by those in the art, in general varying from 5 to 500 nucleotides in length, with primers of between 10 and 100 being preferred, between 15 and 50 being particularly preferred, and from 10 to 35 being especially preferred, depending on the use and amplification technique.

In addition, the different amplification techniques may have further requirements of the primers, as is more fully described below.

Once the hybridization complex between the primer and the target sequence has been formed, an enzyme, sometimes termed an “amplification enzyme”, is used to modify the primer. As for all the methods outlined herein, the enzymes may be added at any point during the assay, either prior to, during, or after the addition of the primers. The identification of the enzyme will depend on the amplification technique used, as is more fully outlined below. Similarly, the modification will depend on the amplification technique, as outlined below, although generally the first step of all the reactions herein is an extension of the primer, that is, nucleotides are added to the primer to extend its length.

Once the enzyme has modified the primer to form a modified primer, the hybridization complex is disassociated. Generally, the amplification steps are repeated for a period of time to allow a number of cycles, depending on the number of copies of the original target sequence and the sensitivity of detection, with cycles ranging from 1 to thousands, with from 10 to 100 cycles being preferred and from 20 to 50 cycles being especially preferred.

After a suitable time or amplification, the modified primer can be moved to a detection module and detected.

In a preferred embodiment, the amplification is target amplification. Target amplification involves the amplification (replication) of the target sequence to be detected, such that the number of copies of the target sequence is increased. Suitable target amplification techniques include, but are not limited to, the polymerase chain reaction (PCR), strand displacement amplification (SDA), and nucleic acid sequence based amplification (NASBA).

In a preferred embodiment, the target amplification technique is PCR. The polymerase chain reaction (PCR) is widely used and described, and involve the use of primer extension combined with thermal cycling to amplify a target sequence; see U.S. Pat. Nos. 4,683,195 and 4,683,202, and PCR Essential Data, J. W. Wiley & sons, Ed. C. R. Newton, 1995, all of which are incorporated by reference. In addition, there are a number of variations of PCR which also find use in the invention, including “quantitative competitive PCR” or “QC-PCR”, “arbitrarily primed PCR” or “AP-PCR”, “immuno-PCR”, “Alu-PCR”, “PCR single strand conformational polymorphism” or “PCR-SSCP”, “reverse transcriptase PCR” or “RT-PCR”, “biotin capture PCR”, “vectorette PCR”. “panhandle PCR”, and “PCR select cDNA subtration”, among others. In one embodiment, the amplification technique is not PCR.

In general, PCR may be briefly described as follows. A double stranded target nucleic acid is denatured, generally by raising the temperature, and then cooled in the presence of an excess of a PCR primer, which then hybridizes to the first target strand. A DNA polymerase then acts to extend the primer, resulting in the synthesis of a new strand forming a hybridization complex. The sample is then heated again, to disassociate the hybridization complex, and the process is repeated. By using a second PCR primer for the complementary target strand, rapid and exponential amplification occurs. Thus PCR steps are denaturation, annealing and extension. The particulars of PCR are well known, and include the use of a thermostabile polymerase such as Taq I polymerase and thermal cycling.

Accordingly, the PCR reaction requires at least one PCR primer and a polymerase.

In a preferred embodiment, the target amplification technique is SDA. Strand displacement amplification (SDA) is generally described in Walker et al., in Molecular Methods for Virus Detection, Academic Press, Inc., 1995, and U.S. Pat. Nos. 5,455,166 and 5,130,238, all of which are hereby expressly incorporated by reference in their entirety.

In general, SDA may be described as follows. A single stranded target nucleic acid, usually a DNA target sequence, is contacted with an SDA primer. An “SDA primer” generally has a length of 25-100 nucleotides, with SDA primers of approximately 35 nucleotides being preferred. An SDA primer is substantially complementary to a region at the 3′ end of the target sequence, and the primer has a sequence at its 5′ end (outside of the region that is complementary to the target) that is a recognition sequence for a restriction endonuclease, sometimes referred to herein as a “nicking enzyme” or a “nicking endonuclease”, as outlined below. The SDA primer then hybridizes to the target sequence. The SDA reaction mixture also contains a polymerase (an “SDA polymerase”, as outlined below) and a mixture of all four deoxynucleoside-triphosphates (also called deoxynucleotides or dNTPs, i.e. dATP, dTTP, dCTP and dGTP), at least one species of which is a substituted or modified dNTP; thus, the SDA primer is modified, i.e. extended, to form a modified primer, sometimes referred to herein as a “newly synthesized strand”. The substituted dNTP is modified such that it will inhibit cleavage in the strand containing the substituted dNTP but will not inhibit cleavage on the other strand. Examples of suitable substituted dNTPs include, but are not limited, 2′deoxyadenosine 5′-O-(1-thiotriphosphate), 5-methyldeoxycytidine 5′-triphosphate, 2′-deoxyuridine 5′-triphosphate, and 7-deaza-2′-deoxyguanosine 5′-triphosphate. In addition, the substitution of the dNTP may occur after incorporation into a newly synthesized strand; for example, a methylase may be used to add methyl groups to the synthesized strand. In addition, if all the nucleotides are substituted, the polymerase may have 5′-3′ exonuclease activity. However, if less than all the nucleotides are substituted, the polymerase preferably lacks 5′-3′ exonuclease activity.

As will be appreciated by those in the art, the recognition site/endonuclease pair can be any of a wide variety of known combinations. The endonuclease is chosen to cleave a strand either at the recognition site, or either 3′ or 5′ to it, without cleaving the complementary sequence, either because the enzyme only cleaves one strand or because of the incorporation of the substituted nucleotides. Suitable recognition site/endonuclease pairs are well known in the art; suitable endonucleases include, but are not limited to, HincII, HindIII, AvaI, Fnu4HI, TthIIII, NcII, BstXI, BamI, etc. A chart depicting suitable enzymes, and their corresponding recognition sites and the modified dNTP to use is found in U.S. Pat. No. 5,455,166, hereby expressly incorporated by reference.

Once nicked, a polymerase (an “SDA polymerase”) is used to extend the newly nicked strand, 5′-3′, thereby creating another newly synthesized strand. The polymerase chosen should be able to intiate 5′-3′ polymerization at a nick site, should also displace the polymerized strand downstream from the nick, and should lack 5′-3′ exonuclease activity (this may be additionally accomplished by the addition of a blocking agent). Thus, suitable polymerases in SDA include, but are not limited to, the Klenow fragment of DNA polymerase 1, SEQUENASE 1.0 and SEQUENASE 2.0 (U.S. Biochemical), T5 DNA polymerase and Phi29 DNA polymerase.

Accordingly, the SDA reaction requires, in no particular order, an SDA primer, an SDA polymerase, a nicking endonuclease, and dNTPs, at least one species of which is modified.

In general, SDA does not require thermocycling. The temperature of the reaction is generally set to be high enough to prevent non-specific hybridization but low enough to allow specific hybridization; this is generally from about 37° C. to about 42° C., depending on the enzymes.

In a preferred embodiment, as for most of the amplification techniques described herein, a second amplification reaction can be done using the complementary target sequence, resulting in a substantial increase in amplification during a set period of time. That is, a second primer nucleic acid is hybridized to a second target sequence, that is substantially complementary to the first target sequence, to form a second hybridization complex. The addition of the enzyme, followed by disassociation of the second hybridization complex, results in the generation of a number of newly synthesized second strands.

In a preferred embodiment, the target amplification technique is nucleic acid sequence based amplification (NASBA). NASBA is generally described in U.S. Pat. No. 5,409,818; Sooknanan et al., Nucleic Acid Sequence-Based Amplification, Ch. 12 (pp. 261-285) of Molecular Methods for Virus Detection, Academic Press, 1995; and “Profiting from Gene-based Diagnostics”, CTB International Publishing Inc., N.J., 1996, all of which are incorporated by reference. NASBA is very similar to both TMA and QBR. Transcription mediated amplification (TMA) is generally described in U.S. Pat. Nos. 5,399,491, 5,888,779, 5,705,365, 5,710,029, all of which are incorporated by reference. The main difference between NASBA and TMA is that NASBA utilizes the addition of RNAse H to effect RNA degradation, and TMA relies on inherent RNAse H activity of the reverse transcriptase.

In general, these techniques may be described as follows. A single stranded target nucleic acid, usually an RNA target sequence (sometimes referred to herein as “the first target sequence” or “the first template”), is contacted with a first primer, generally referred to herein as a “NASBA primer” (although “TMA primer” is also suitable). Starting with a DNA target sequence is described below. These primers generally have a length of 25-100 nucleotides, with NASBA primers of approximately 50-75 nucleotides being preferred. The first primer is preferably a DNA primer that has at its 3′ end a sequence that is substantially complementary to the 3′ end of the first template. The first primer also has an RNA polymerase promoter at its 5′ end (or its complement (antisense), depending on the configuration of the system). The first primer is then hybridized to the first template to form a first hybridization complex. The reaction mixture also includes a reverse transcriptase enzyme (an “NASBA reverse transcriptase”) and a mixture of the four dNTPs, such that the first NASBA primer is modified, i.e. extended, to form a modified first primer, comprising a hybridization complex of RNA (the first template) and DNA (the newly synthesized strand).

By “reverse transcriptase” or “RNA-directed DNA polymerase” herein is meant an enzyme capable of synthesizing DNA from a DNA primer and an RNA template. Suitable RNA-directed DNA polymerases include, but are not limited to, avian myloblastosis virus reverse transcriptase (“AMV RT”) and the Moloney murine leukemia virus RT. When the amplification reaction is TMA, the reverse transcriptase enzyme further comprises a RNA degrading activity as outlined below.

In addition to the components listed above, the NASBA reaction also includes an RNA degrading enzyme, also sometimes referred to herein as a ribonuclease, that will hydrolyze RNA of an RNA:DNA hybrid without hydrolyzing single- or double-stranded RNA or DNA. Suitable ribonucleases include, but are not limited to, RNase H from E. coli and calf thymus.

The ribonuclease activity degrades the first RNA template in the hybridization complex, resulting in a disassociation of the hybridization complex leaving a first single stranded newly synthesized DNA strand, sometimes referred to herein as “the second template”.

In addition, the NASBA reaction also includes a second NASBA primer, generally comprising DNA (although as for all the probes herein, including primers, nucleic acid analogs may also be used). This second NASBA primer has a sequence at its 3′ end that is substantially complementary to the 3′ end of the second template, and also contains an antisense sequence for a functional promoter and the antisense sequence of a transcription initiation site. Thus, this primer sequence, when used as a template for synthesis of the third DNA template, contains sufficient information to allow specific and efficient binding of an RNA polymerase and initiation of transcription at the desired site. Preferred embodiments utilizes the antisense promoter and transcription initiation site are that of the T7 RNA polymerase, although other RNA polymerase promoters and initiation sites can be used as well, as outlined below.

The second primer hybridizes to the second template, and a DNA polymerase, also termed a “DNA-directed DNA polymerase”, also present in the reaction, synthesizes a third template (a second newly synthesized DNA strand), resulting in second hybridization complex comprising two newly synthesized DNA strands.

Finally, the inclusion of an RNA polymerase and the required four ribonucleoside triphosphates (ribonucleotides or NTPs) results in the synthesis of an RNA strand (a third newly synthesized strand that is essentially the same as the first template). The RNA polymerase, sometimes referred to herein as a “DNA-directed RNA polymerase”, recognizes the promoter and specifically initiates RNA synthesis at the initiation site. In addition, the RNA polymerase preferably synthesizes several copies of RNA per DNA duplex. Preferred RNA polymerases include, but are not limited to, T7 RNA polymerase, and other bacteriophage RNA polymerases including those of phage T3, phage φII, Salmonella phage sp6, or Pseudomonase phage gh-1.

In some embodiments, TMA and NASBA are used with starting DNA target sequences. In this embodiment, it is necessary to utilize the first primer comprising the RNA polymerase promoter and a DNA polymerase enzyme to generate a double stranded DNA hybrid with the newly synthesized strand comprising the promoter sequence. The hybrid is then denatured and the second primer added.

Accordingly, the NASBA reaction requires, in no particular order, a first NASBA primer, a second NASBA primer comprising an antisense sequence of an RNA polymerase promoter, an RNA polymerase that recognizes the promoter, a reverse transcriptase, a DNA polymerase, an RNA degrading enzyme, NTPs and dNTPs, in addition to the detection components outlined below.

These components result in a single starting RNA template generating a single DNA duplex; however, since this DNA duplex results in the creation of multiple RNA strands, which can then be used to initiate the reaction again, amplification proceeds rapidly.

Accordingly, the TMA reaction requires, in no particular order, a first TMA primer, a second TMA primer comprising an antisense sequence of an RNA polymerase promoter, an RNA polymerase that recognizes the promoter, a reverse transcriptase with RNA degrading activity, a DNA polymerase, NTPs and dNTPs, in addition to the detection components outlined below.

These components result in a single starting RNA template generating a single DNA duplex; however, since this DNA duplex results in the creation of multiple RNA strands, which can then be used to initiate the reaction again, amplification proceeds rapidly.

In a preferred embodiment, the amplification technique is signal amplification. Signal amplification involves the use of limited number of target molecules as templates to either generate multiple signalling probes or allow the use of multiple signalling probes. Signal amplification strategies include LCR, CPT, Invader™, and the use of amplification probes in sandwich assays.

In a preferred embodiment, the signal amplification technique is the oligonucleotide ligation assay (OLA), sometimes referred to as the ligation chain reaction (LCR). The method can be run in two different ways; in a first embodiment, only one strand of a target sequence is used as a template for ligation (OLA); alternatively, both strands may be used (OLA). See generally U.S. Pat. Nos. 5,185,243 and 5,573,907; EP 0 320 308 B1; EP 0 336 731 B1; EP 0 439 182 B1; WO 90/01069; WO 89/12696; and WO 89/09835, and U.S. S. Nos. 60/078,102 and 60/073,011, all of which are incorporated by reference.

In a preferred embodiment, the single-stranded target sequence comprises a first target domain and a second target domain, and a first LCR primer and a second LCR primer nucleic acids are added, that are substantially complementary to its respective target domain and thus will hybridize to the target domains. These target domains may be directly adjacent, i.e. contiguous, or separated by a number of nucleotides. If they are non-contiguous, nucleotides are added along with means to join nucleotides, such as a polymerase, that will add the nucleotides to one of the primers. The two LCR primers are then covalently attached, for example using a ligase enzyme such as is known in the art. This forms a first hybridization complex comprising the ligated probe and the target sequence. This hybridization complex is then denatured (disassociated), and the process is repeated to generate a pool of ligated probes.

In a preferred embodiment, LCR is done for two strands of a double-stranded target sequence. The target sequence is denatured, and two sets of probes are added: one set as outlined above for one strand of the target, and a separate set (i.e. third and fourth primer robe nucleic acids) for the other strand of the target. In a preferred embodiment, the first and third probes will hybridize, and the second and fourth probes will hybridize, such that amplification can occur. That is, when the first and second probes have been attached, the ligated probe can now be used as a template, in addition to the second target sequence, for the attachment of the third and fourth probes. Similarly, the ligated third and fourth probes will serve as a template for the attachment of the first and second probes, in addition to the first target strand. In this way, an exponential, rather than just a linear, amplification can occur.

A variation of LCR utilizes a “chemical ligation” of sorts, as is generally outlined in U.S. Pat. Nos. 5,616,464 and 5,767,259, both of which are hereby expressly incorporated by reference in their entirety. In this embodiment, similar to LCR, a pair of primers are utilized, wherein the first primer is substantially complementary to a first domain of the target and the second primer is substantially complementary to an adjacent second domain of the target (although, as for LCR, if a “gap” exists, a polymerase and dNTPs may be added to “fill in” the gap). Each primer has a portion that acts as a “side chain” that does not bind the target sequence and acts one half of a stem structure that interacts non-covalently through hydrogen bonding, salt bridges, van der Waal's forces, etc. Preferred embodiments utilize substantially complementary nucleic acids as the side chains. Thus, upon hybridization of the primers to the target sequence, the side chains of the primers are brought into spatial proximity, and, if the side chains comprise nucleic acids as well, can also form side chain hybridization complexes.

At least one of the side chains of the primers comprises an activatable cross-linking agent, generally covalently attached to the side chain, that upon activation, results in a chemical cross-link or chemical ligation. The activatible group may comprise any moiety that will allow cross-linking of the side chains, and include groups activated chemically, photonically and thermally, with photoactivatable groups being preferred. In some embodiments a single activatable group on one of the side chains is enough to result in cross-linking via interaction to a functional group on the other side chain; in alternate embodiments, activatable groups are required on each side chain.

Once the hybridization complex is formed, and the cross-linking agent has been activated such that the primers have been covalently attached, the reaction is subjected to conditions to allow for the disassociation of the hybridization complex, thus freeing up the target to serve as a template for the next ligation or cross-linking. In this way, signal amplification occurs, and can be detected as outlined herein.

In a preferred embodiment the signal amplification technique is RCA. Rolling-circle amplification is generally described in Baner et al. (1998) Nuc. Acids Res. 26:5073-5078; Barany, F. (1991) Proc. Natl. Acad. Sci. USA 88:189-193; Lizardi et al. (1998) Nat. Genet. 19:225-232; Zhang et al., Gene 211:277 (1998); and Daubendiek et al., Nature Biotech. 15:273 (1997); all of which are incorporated by reference in their entirety.

In general, RCA may be described as follows. First, as is outlined in more detail below, a single RCA probe is hybridized with a target nucleic acid. Each terminus of the probe hybridizes adjacently on the target nucleic acid (or alternatively, there are intervening nucleotides that can be “filled in” using a polymerase and dNTPs, as outlined below) and the OLA assay as described above occurs. When ligated, the probe is circularized while hybridized to the target nucleic acid. Addition of a primer, a polymerase and dNTPs results in extension of the circular probe. However, since the probe has no terminus, the polymerase continues to extend the probe repeatedly. Thus results in amplification of the circular probe. This very large concatamer can be detected intact, as described below, or can be cleaved in a variety of ways to form smaller amplicons for detection as outlined herein.

Accordingly, in an preferred embodiment, a single oligonucleotide is used both for OLA and as the circular template for RCA (referred to herein as a “padlock probe” or a “RCA probe”). That is, each terminus of the oligonucleotide contains sequence complementary to the target nucleic acid and functions as an OLA primer as described above. That is, the first end of the RCA probe is substantially complementary to a first target domain, and the second end of the RCA probe is substantially complementary to a second target domain, adjacent (either directly or indirectly, as outlined herein) to the first domain. Hybridization of the probe to the target nucleic acid results in the formation of a hybridization complex. Ligation of the “primers” (which are the discrete ends of a single oligonucleotide, the RCA probe) results in the formation of a modified hybridization complex containing a circular probe i.e. an RCA template complex. That is, the oligonucleotide is circularized while still hybridized with the target nucleic acid. This serves as a circular template for RCA. Addition of a primer, a polymerase and the required dNTPs to the RCA template complex results in the formation of an amplified product nucleic acid. Following RCA, the amplified product nucleic acid is detected as outlined herein. This can be accomplished in a variety of ways; for example, the polymerase may incorporate labeled nucleotides; a labeled primer may be used, or alternatively, a label probe is used that is substantially complementary to a portion of the RCA probe and comprises at least one label is used.

Accordingly, the present invention provides RCA probes (sometimes referred to herein as “rolling circle probes (RCPs) or “padlock probes” (PPs)). The RCPs may comprise any number of elements, including a first and second ligation sequence, a cleavage site, a priming site, a capture sequence, nucleotide analogs, and a label sequence.

In a preferred embodiment, the RCP comprises first and second ligation sequences. As outlined above for OLA, the ligation sequences are substantially complementary to adjacent domains of the target sequence. The domains may be directly adjacent (i.e. with no intervening bases between the 3′ end of the first and the 5′ of the second) or indirectly adjacent, with from 1 to 100 or more bases in between.

In a preferred embodiment, the RCPs comprise a cleavage site, such that either after or during the rolling circle amplification, the RCP concatamer may be cleaved into amplicons. In some embodiments, this facilitates the detection, since the amplicons are generally smaller and exhibit favorable hybridization kinetics on the surface. As will be appreciated by those in the art, the cleavage site can take on a number of forms, including, but not limited to, the use of restriction sites in the probe, the use of ribozyme sequences, or through the use or incorporation of nucleic acid cleavage moieties.

In a preferred embodiment, the padlock probe contains a restriction site. The restriction endonuclease site allows for cleavage of the long concatamers that are typically the result of RCA into smaller individual units that hybridize either more efficiently or faster to surface bound capture probes. Thus, following RCA (or in some cases, during the reaction), the product nucleic acid is contacted with the appropriate restriction endonuclease. This results in cleavage of the product nucleic acid into smaller fragments. The fragments are then hybridized with the capture probe that is immobilized resulting in a concentration of product fragments onto the detection electrode. Again, as outlined herein, these fragments can be detected in one of two ways: either labeled nucleotides are incorporated during the replication step, for example either as labeled individual dNTPs or through the use of a labeled primer, or an additional label probe is added.

In a preferred embodiment, the restriction site is a single-stranded restriction site chosen such that its complement occurs only once in the RCP.

In a preferred embodiment, the cleavage site is a ribozyme cleavage site as is generally described in Daubendiek et al., Nature Biotech. 15:273 (1997), hereby expressly incorporated by reference. In this embodiment, by using RCPs that encode catalytic RNAs, NTPs and an RNA polymerase, the resulting concatamer can self cleave, ultimately forming monomeric amplicons.

In a preferred embodiment, cleavage is accomplished using DNA cleavage reagents. For example, as is known in the art, there are a number of intercalating moieties that can effect cleavage, for example using light.

In a preferred embodiment, the RCPs do not comprise a cleavage site. Instead, the size of the RCP is designed such that it may hybridize “smoothly” to many capture probes on a surface. Alternatively, the reaction may be cycled such that very long concatamers are not formed.

In a preferred embodiment, the RCPs comprise a priming site, to allow the binding of a DNA polymerase primer. As is known in the art, many DNA polymerases require double stranded nucleic acid and a free terminus to allow nucleic acid synthesis. However, in some cases, for example when RNA polymerases are used, a primer may not be required (see Daubendiek, supra). Similarly, depending on the size and orientation of the target strand, it is possible that a free end of the target sequence can serve as the primer; see Baner et al., supra.

Thus, in a preferred embodiment, the padlock probe also contains a priming site for priming the RCA reaction. That is, each padlock probe comprises a sequence to which a primer nucleic acid hybridizes forming a template for the polymerase. The primer can be found in any portion of the circular probe. In a preferred embodiment, the primer is located at a discrete site in the probe. In this embodiment, the primer site in each distinct padlock probe is identical, although this is not required. Advantages of using primer sites with identical sequences include the ability to use only a single primer oligonucleotide to prime the RCA assay with a plurality of different hybridization complexes. That is, the padlock probe hybridizes uniquely to the target nucleic acid to which it is designed. A single primer hybridizes to all of the unique hybridization complexes forming a priming site for the polymerase. RCA then proceeds from an identical locus within each unique padlock probe of the hybridization complexes.

In an alternative embodiment, the primer site can overlap, encompass, or reside within any of the above-described elements of the padlock probe. That is, the primer can be found, for example, overlapping or within the restriction site or the identifier sequence. In this embodiment, it is necessary that the primer nucleic acid is designed to base pair with the chosen primer site.

In a preferred embodiment, the primer may comprise a covalently attached label.

In a preferred embodiment, the RCPs comprise a capture sequence. A capture sequence, as is outlined herein, is substantially complementary to a capture probe, as outlined herein.

In a preferred embodiment, the RCPs comprise a label sequence; i.e. a sequence that can be used to bind label probes and is substantially complementary to a label probe. In one embodiment, it is possible to use the same label sequence and label probe for all padlock probes on an array; alternatively, each padlock probe can have a different label sequence.

In a preferred embodiment, the RCP/primer sets are designed to allow an additional level of amplification, sometimes referred to as “hyperbranching” or “cascade amplification”. As described in Zhang et al., supra, by using several priming sequences and primers, a first concatamer can serve as the template for additional concatamers. In this embodiment, a polymerase that has high displacement activity is preferably used. In this embodiment, a first antisense primer is used, followed by the use of sense primers, to generate large numbers of concatamers and amplicons, when cleavage is used.

Thus, the invention provides for methods of detecting using RCPs as described herein. Once the ligation sequences of the RCP have hybridized to the target, forming a first hybridization complex, the ends of the RCP are ligated together as outlined above for OLA. The RCP primer is added, if necessary, along with a polymerase and dNTPs (or NTPs, if necessary).

The polymerase can be any polymerase as outlined herein, but is preferably one lacking 3′ exonuclease activity (3′ exo⁻). Examples of suitable polymerase include but are not limited to exonuclease minus DNA Polymerase I large (Klenow) Fragment, Phi29 DNA polymerase, Taq DNA Polymerase and the like. In addition, in some embodiments, a polymerase that will replicate single-stranded DNA (i.e. without a primer forming a double stranded section) can be used.

Thus, in a preferred embodiment the OLA/RCA is performed in solution followed by restriction endonuclease cleavage of the RCA product. The cleaved product is then applied to an array as described herein. The incorporation of an endonuclease site allows the generation of short, easily hybridizable sequences. Furthermore, the unique capture sequence in each rolling circle padlock probe sequence allows diverse sets of nucleic acid sequences to be analyzed in parallel on an array, since each sequence is resolved on the basis of hybridization specificity.

In a preferred embodiment, the polymerase creates more than 100 copies of the circular DNA. In more preferred embodiments the polymerase creates more than 1000 copies of the circular DNA; while in a most preferred embodiment the polymerase creates more than 10,000 copies or more than 50,000 copies of the template.

The RCA as described herein finds use in allowing highly specific and highly sensitive detection of nucleic acid target sequences. In particular, the method finds use in improving the multiplexing ability of DNA arrays and eliminating costly sample or target preparation. As an example, a substantial savings in cost can be realized by directly analyzing genomic DNA on an array, rather than employing an intermediate PCR amplification step. The method finds use in examining genomic DNA and other samples including mRNA.

In addition the RCA finds use in allowing rolling circle amplification products to be easily detected by hybridization to probes in a solid-phase format. An additional advantage of the RCA is that it provides the capability of multiplex analysis so that large numbers of sequences can be analyzed in parallel. By combining the sensitivity of RCA and parallel detection on arrays, many sequences can be analyzed directly from genomic DNA.

In a preferred embodiment, the signal amplification technique is CPT. CPT technology is described in a number of patents and patent applications, including U.S. Pat. Nos. 5,011,769, 5,403,711, 5,660,988, and 4,876,187, and PCT published applications WO 95/05480, WO 95/1416, and WO 95/00667, and U.S. Ser. No. 09/014,304, all of which are expressly incorporated by reference in their entirety.

Generally, CPT may be described as follows. A CPT primer (also sometimes referred to herein as a “scissile primer”), comprises two probe sequences separated by a scissile linkage. The CPT primer is substantially complementary to the target sequence and thus will hybridize to it to form a hybridization complex. The scissile linkage is cleaved, without cleaving the target sequence, resulting in the two probe sequences being separated. The two probe sequences can thus be more easily disassociated from the target, and the reaction can be repeated any number of times. The cleaved primer is then detected as outlined herein.

By “scissile linkage” herein is meant a linkage within the scissile probe that can be cleaved when the probe is part of a hybridization complex, that is, when a double-stranded complex is formed. It is important that the scissile linkage cleave only the scissile probe and not the sequence to which it is hybridized (i.e. either the target sequence or a probe sequence), such that the target sequence may be reused in the reaction for amplification of the signal. As used herein, the scissile linkage, is any connecting chemical structure which joins two probe sequences and which is capable of being selectively cleaved without cleavage of either the probe sequences or the sequence to which the scissile probe is hybridized. The scissile linkage may be a single bond, or a multiple unit sequence. As will be appreciated by those in the art, a number of possible scissile linkages may be used.

In a preferred embodiment, the scissile linkage comprises RNA. This system, previously described in as outlined above, is based on the fact that certain double-stranded nucleases, particularly ribonucleases, will nick or excise RNA nucleosides from a RNA:DNA hybridization complex. Of particular use in this embodiment is RNAseH, Exo III, and reverse transcriptase.

In one embodiment, the entire scissile probe is made of RNA, the nicking is facilitated especially when carried out with a double-stranded ribonuclease, such as RNAseH or Exo III. RNA probes made entirely of RNA sequences are particularly useful because first, they can be more easily produced enzymatically, and second, they have more cleavage sites which are accessible to nicking or cleaving by a nicking agent, such as the ribonucleases. Thus, scissile probes made entirely of RNA do not rely on a scissile linkage since the scissile linkage is inherent in the probe.

In a preferred embodiment, Invader™ technology is used. Invader™ technology is based on structure-specific polymerases that cleave nucleic acids in a site-specific manner. Two probes are used: an “invader” probe and a “signaling” probe, that adjacently hybridize to a target sequence with a non-complementary overlap. The enzyme cleaves at the overlap due to its recognition of the “tail”, and releases the “tail”. This can then be detected. The Invaders technology is described in U.S. Pat. Nos. 5,846,717; 5,614,402; 5,719,028; 5,541,311; and 5,843,669, all of which are hereby incorporated by reference.

Accordingly, the invention provides a first primer, sometimes referred to herein as an “invader primer”, that hybridizes to a first domain of a target sequence, and a second primer, sometimes referred to herein as the signaling primer, that hybridizes to a second domain of the target sequence. The first and second target domains are adjacent. The signaling primer further comprises an overlap sequence, comprising at least one nucleotide, that is perfectly complementary to at least one nucleotide of the first target domain, and a non-complementary “tail” region. The cleavage enzyme recognizes the overlap structure and the noncomplementary tail, and cleaves the tail from the second primer. Suitable cleavage enzymes are described in the Patents outlined above, and include, but are not limited to, 5′ thermostable nucleases from Thermus species, including Thermus aquaticus, Thermus flavus and Thermus thermophilus. The entire reaction is done isothermally at a temperature such that upon cleavage, the invader probe and the cleaved signaling probe come off the target stand, and new primers can bind. In this way large amounts of cleaved signaling probe (i.e. “tails”) are made. The uncleaved signaling probes are removed (for example by binding to a solid support such as a bead, either on the basis of the sequence or through the use of a binding ligand attached to the portion of the signaling probe that hybridizes to the target). The cleaved signalling probes are then detected as outlined herein.

In this way, a number of target molecules are made. As is more fully outlined below, these reactions (that is, the products of these reactions) can be detected in a number of ways, as is generally outlined in Ser. Nos. 09/458,553; 09/458,501; 09/572,187; 09/495,992; 09/344,217; WO00/31148; U.S. Ser. Nos. 09/439,889; 09/438,209; 09/344,620; PCTUS00/17422; Ser. No. 09/478,727, all of which are expressly incorporated by reference in their entirety.

In addition to the components outlined above for reaction modules, as described in U.S. Pat. No. 5,587,128, the reaction module may comprise a composition, either in solution or adhered to the surface of the reaction module, that prevents the inhibition of an amplification reaction by the composition of the well. For example, the wall surfaces may be coated with a silane, for example using a silanization reagent such as dimethylchlorosilane, or coated with a siliconizing reagent such as Aquasil™ or Surfacil™ (Pierce, Rockford, Ill.), which are organosilanes containing a hydrolyzable group. This hydrolyzable group can hydrolyze in solution to form a silanol that can polymerize and form a tightly bonded film over the surface of the chamber. The coating may also include a blocking agent that can react with the film to further reduce inhibition; suitable blocking agents include amino acid polymers and polymers such as polyvinylpyrrolidone, polyadenylic acid and polymaleimide. Alternatively, for silicon substrates, a silicon oxide film may be provided on the walls, or the reaction chamber can be coated with a relatively inert polymer such as a polyvinylchloride. In addition, it may be desirable to add blocking polynucleotides to occupy any binding sites on the surface of the chamber.

In a preferred embodiment, the biological reaction chamber allows enzymatic cleavage or alteration of the target analyte. For example, restriction endonucleases may be used to cleave target nucleic acids comprising target sequences, for example genomic DNA, into smaller fragments to facilitate either amplification or detection. Alternatively, when the target analyte is a protein, it may be cleaved by a protease. Other types of enzymatic hydrolysis may also be done, depending on the composition of the target analyte. In addition, as outlined herein, the target analyte may comprise an enzyme and the reaction chamber comprises a substrate that is then cleaved to form a detectable product.

In addition, in one embodiment the reaction module includes a chamber for the physical alteration of all or part of the sample, for example for shearing genomic or large nucleic acids, nuclear lysis, ultrasound, etc.

The present invention provides microfluidic devices for manipulating polarizable analytes via dielectrophoresis and detecting target analytes. Accordingly, preferred microfluidic devices of the present invention comprise at least one detection module. By “detection module” herein is meant that components are provided and organized to provide detection functionality, either substantially integrated with other modules, such as the concentration modules described above, or independent and in fluidic communication with, or capable of being brought into fluidic communication with other modules. In addition, both detection and/or quantification may be done.

As will be appreciated by those in the art, a wide variety of detection modes may be utilized in the present invention, including, but not limited to, methods based on electronic, electrochemical, or optical detection, electrophoretic methods, mass spectroscopy methods, or any other electromagnetic-based detection system, etc.

Preferred embodiments utilize detection methods based on capture to a solid support, followed by electronic, electrochemical, or optical detection. As is known in the art, there are a wide variety of array technologies that will find use in the present invention. By “array” or “biochip” herein is meant a plurality of capture ligands in an array format; the size of the array will depend on the composition and end use of the array. Nucleic acids arrays are well known in the art, and can be classified in a number of ways; both ordered arrays (e.g. the ability to resolve chemistries at discrete sites), and random arrays are included. Ordered arrays include, but are not limited to, those made using photolithography techniques (Affymetrix GeneChip™), spotting techniques (Synteni and others), printing techniques (Hewlett Packard and Rosetta), three dimensional “gel pad” arrays, etc. In addition, there are detection methods based on electrode arrays, that can be used for detection, quantification and genotyping; see for example WO 98/20162; U.S. Pat. No. 6,232,062; WO98/12430; WO00/16089; WO99/57317; WO01/35100; WO00/62931; WO01/06016; WO01/07665; WO01/54813; WO01/42508; and U.S. Ser. Nos. 09/459,685 and 09/458,533; all of which are hereby incorporated by reference.

Detection modules generally comprise capture probes immobilized on a detection surface for binding target analytes. By “capture probe”, “binding ligand” or “binding species” herein is meant a compound that is used to probe for the presence of the target analyte, that will bind to the target analyte. Generally, the capture binding ligand allows the attachment of a target analyte to a detection surface, for the purposes of detection. As is more fully outlined below, attachment of the target analyte to the capture binding ligand may be direct (i.e. the target analyte binds to the capture binding ligand) or indirect (one or more capture extender ligands may be used).

In a preferred embodiment, the binding is specific, and the binding ligand is part of a binding pair. By “specifically bind” herein is meant that the ligand binds the analyte, with specificity sufficient to differentiate between the analyte and other components or contaminants of the test sample. However, as will be appreciated by those in the art, it will be possible to detect analytes using binding that is not highly specific; for example, the systems may use different binding ligands, for example an array of different ligands, and detection of any particular analyte is via its “signature” of binding to a panel of binding ligands, similar to the manner in which “electronic noses” work. The binding should be sufficient to allow the analyte to remain bound under the conditions of the assay, including wash steps to remove non-specific binding. In some embodiments, for example in the detection of certain biomolecules, the binding constants of the analyte to the binding ligand will be at least about 10⁻⁴ to 10⁻⁶⁻¹, with at least about 10⁻⁵ to 10⁻⁹ being preferred and at least about 10⁻⁷ to 10⁻⁹⁻¹ being particularly preferred.

As will be appreciated by those in the art, the composition of the binding ligand will depend on the composition of the target analyte. Binding ligands to a wide variety of analytes are known or can be readily found using known techniques. For example, when the analyte is a single-stranded nucleic acid, the binding ligand is generally a substantially complementary nucleic acid. Alternatively, as is generally described in U.S. Pat. Nos. 5,270,163, 5,475,096, 5,567,588, 5,595,877, 5,637,459, 5,683,867, 5,705,337, and related patents, hereby incorporated by reference, nucleic acid “aptamers” can be developed for binding to virtually any target analyte. Similarly the analyte may be a nucleic acid binding protein and the capture binding ligand is either a single-stranded or double-stranded nucleic acid; alternatively, the binding ligand may be a nucleic acid binding protein when the analyte is a single or double-stranded nucleic acid. When the analyte is a protein, the binding ligands include proteins (particularly including antibodies or fragments thereof (FAbs, etc.)), small molecules, or aptamers, described above. Preferred binding ligand proteins include peptides. For example, when the analyte is an enzyme, suitable binding ligands include substrates, inhibitors, and other proteins that bind the enzyme, i.e. components of a multi-enzyme (or protein) complex. As will be appreciated by those in the art, any two molecules that will associate, preferably specifically, may be used, either as the analyte or the binding ligand. Suitable analyte/binding ligand pairs include, but are not limited to, antibodies/antigens, receptors/ligand, proteins/nucleic acids; nucleic acids/nucleic acids, enzymes/substrates and/or inhibitors, carbohydrates (including glycoproteins and glycolipids)/lectins, carbohydrates and other binding partners, proteins/proteins; and protein/small molecules. These may be wild-type or derivative sequences. In a preferred embodiment, the binding ligands are portions (particularly the extracellular portions) of cell surface receptors that are known to multimerize, such as the growth hormone receptor, glucose transporters (particularly GLUT4 receptor), transferrin receptor, epidermal growth factor receptor, low density lipoprotein receptor, high density lipoprotein receptor, leptin receptor, interleukin receptors including IL-1, IL-2, IL-3, IL-4, IL-5, IL-6, IL-7, IL-8, IL-9, IL-11, IL-12, IL-13, IL-15 and IL-17 receptors, VEGF receptor, PDGF receptor, EPO receptor, TPO receptor, ciliary neurotrophic factor receptor, prolactin receptor, and T-cell receptors. Similarly, there is a wide body of literature relating to the development of binding partners based on combinatorial chemistry methods.

In a preferred embodiment, the target analytes are nucleic acids and the capture binding ligands are nucleic acid probes (generally referred to herein as “capture probes”). Probes of the present invention are designed to be complementary to a target sequence (either the target sequence of the sample or to other probe sequences), such that hybridization of the target sequence and the probes of the present invention occurs. As outlined below, this complementarity need not be perfect; there may be any number of base pair mismatches which will interfere with hybridization between the target sequence and the single stranded nucleic acids of the present invention. However, if the number of mutations is so great that no hybridization can occur under even the least stringent of hybridization conditions, the sequence is not a complementary target sequence. Thus, by “substantially complementary” herein is meant that the probes are sufficiently complementary to the target sequences to hybridize under normal reaction conditions.

Generally, the nucleic acid compositions of the invention are useful as oligonucleotide probes. As is appreciated by those in the art, the length of the probe will vary with the length of the target sequence and the hybridization and wash conditions. Generally, oligonucleotide probes range from about 8 to about 50 nucleotides, with from about 10 to about 30 being preferred and from about 12 to about 25 being especially preferred. In some cases, very long probes may be used, e.g. 50 to 200-300 nucleotides in length.

A variety of hybridization conditions may be used in the present invention, including high, moderate and low stringency conditions; see for example Maniatis et al., Molecular Cloning: A Laboratory Manual, 2d Edition, 1989, and Short Protocols in Molecular Biology, ed. Ausubel, et al, hereby incorporated by reference. The hybridization conditions may also vary when a non-ionic backbone, i.e. PNA is used, as is known in the art. In addition, cross-linking agents may be added after target binding to cross-link, i.e. covalently attach, the two strands of the hybridization complex.

In this embodiment, when the binding ligand is a nucleic acid, preferred compositions and techniques are outlined in U.S. Pat. Nos. 5,591,578; 5,824,473; 5,705,348; 5,780,234 and 5,770,369; U.S. Ser. Nos. 08/873,598 08/911,589; WO 98/20162; WO98/12430; WO98/57158; WO 00/16089) WO99/57317; WO99/67425; WO00/24941; PCT US00/10903; WO00/38836; WO99/37819; WO99/57319 and PCTUS00/20476; and related materials, all of which are expressly incorporated by reference in their entirety.

The method of attachment of the capture binding ligands to the detection surface can be done in a variety of ways, depending on the composition of the capture binding ligand and the composition of the detection surface. Both direct attachment (e.g. the capture binding ligand such as a nucleic acid probe is directly attached to a conductive polymer layer, gel pad layer, glass substrate, etc.), and indirect attachment, using an attachment linker, can be done. In general, both ways utilize functional groups on the capture binding ligands, the attachment linker, and the detection surface for attachment. Preferred functional groups for attachment are amino groups, carboxy groups, oxo groups and thiol groups. These functional groups can then be attached, either directly or indirectly through the use of a linker, sometimes depicted herein as “Z”. Linkers are well known in the art; for example, homo-or hetero-bifunctional linkers as are well known (see 1994 Pierce Chemical Company catalog, technical section on cross-linkers, pages 155-200, incorporated herein by reference). Preferred modifications to the target analytes useful in the practice of the invention include but are not limited to —OH, —NH₂, —SH, —COOR (where R=H, lower (C₁₋₁₂) alkyl, aryl, heterocyclic alkyl or aryl, or a metal ion), —CN, or —CHO. Immobilization of such derivatized probes is accomplished by direct attaching of the probe molecules on the detection surface through a functional group such —OH, —SH, —NH₂.

Alternatively, probe molecules can be efficiently immobilized on the detection surface through an intermediate species, termed a “spacer.” In these embodiments, the surface of the detection surface is first modified with an intermediate species that carries functional groups such as hydroxyl (—OH), amino (—NH₂), thiol (—SH), carboxyl ester (—COOR, where R=H, lower (C₁₋₁₂) alkyl, aryl, heterocyclic alkyl or aryl, or a metal ion), nitrile (—CN), or aldehylde (—CHO), which can react with the probe molecules functionalized with complementary members of the aforementioned anchoring groups.

There are three general ways that the assays of the invention are run. In a first embodiment, the target analyte is labeled; binding of the target analyte thus provides the label at the surface of the solid support. Alternatively, in a second embodiment, unlabeled target analytes are used, and a “sandwich” format is utilized; in this embodiment, there are at least two binding ligands used per target analyte molecule; a “capture” or “anchor” binding ligand (also referred to herein as a “capture probe”, particularly in reference to a nucleic acid binding ligand) that is attached to the detection surface as described herein, and a soluble binding ligand (frequently referred to herein as a “signaling probe” or “label probe”), that binds independently to the target analyte, and either directly or indirectly comprises at least one label. In a third embodiment, as further outlined below, none of the compounds comprises a label, and the system relies on changes in electronic properties for detection.

A variety of detection methods may be used, including, but not limited to, optical detection (as a result of spectral changes upon changes in redox states), which includes fluorescence, phosphorescence, luminescence, chemiluminescence, electrochemiluminescence, and refractive index; and electronic detection, including, but not limited to, amperommetry, voltammetry, capacitance and impedance. These methods include time or frequency dependent methods based on AC or DC currents, pulsed methods, lock-in techniques, filtering (high pass, low pass, band pass), and time-resolved techniques including time-resolved fluorescence.

In some embodiments, the detection module is configured to allow for optical detection of target analytes. Binding ligands are immobilized on a detection surface. The detection surface may comprise any surface suitable for the attachment of the binding ligands, and preferably comprises a gel pad, more preferably a polyacrylamide gel pad. Particularly preferred embodiments utilize systems outlined in WO 01/54814, incorporated herein in its entirety. Generally, optical detection of target analytes involve providing a colored or luminescent dye as a ‘label’ on the target analyte. Preferred labels include, but are not limited to, fluorescent lanthamide complexes, including those of Europium and Terbium, fluorescein, rhodamine, tetramethylrhodamine, eosin, erythrosin, coumarin, methyl-coumarins, pyrene, Malacite green, stilbene, Lucifer Yellow, Cascade Blue™, Texas Red, 1,1′-[1,3-propanediylbis[(dimethylimino-3,1-propanediyl]]bis[4-[(3-methyl-2(3H)-benzoxazolylidene)methyl]]-,tetraioide, which is sold under the name YOYO-1, and others described in the 6th Edition of the Molecular Probes Handbook by Richard P. Haugland, hereby expressly incorporated by reference.

After binding, a variety of techniques allow for the detection of radiation emitted by the above labels. These techniques include using fiber optic sensors with nucleic acid probes in solution or attached to the fiber optic. Fluorescence is monitored using a photomultiplier tube or other light detection instrument attached to the fiber optic.

In addition, scanning fluorescence detectors such as the Fluorimager sold by Molecular Dynamics are ideally suited to monitoring the fluorescence of modified nucleic acid molecules arrayed on solid surfaces. The advantage of this system is the large number of electron transfer probes that can be scanned at once using chips covered with thousands of distinct nucleic acid probes.

Further, as is known in the art, photodiodes, confocal microscopes, CCD cameras, or active pixel systems maybe used to image the radiation emitted by fluorescent labels.

As will be appreciated by those in the art, there are a variety of electronic and electrochemical detection techniques that can be used. In some embodiments, (e.g. electrochemical detection), hybridization complexes are formed that comprise a target sequence and a capture probe. The target sequence can comprise an electrochemically active reporter (also referred to herein as an electron transfer moiety (ETM)), such as a transition metal complex, defined below. Alternatively, in “sandwich” formats, the hybridization complex further comprises a label probe, that hybridizes to a domain of the target sequence, and comprises the label.

In a preferred embodiment, the detection technique comprises a “sandwich” assay, as is generally described in U.S. S. No. 60/073,011 and in U.S. Pat. Nos. 5,681,702, 5,597,909, 5,545,730, 5,594,117, 5,591,584, 5,571,670, 5,580,731, 5,571,670, 5,591,584, 5,624,802, 5,635,352, 5,594,118, 5,359,100, 5,124,246 and 5,681,697, all of which are hereby incorporated by reference. Although sandwich assays do not result in the alteration of primers, sandwich assays can be considered signal amplification techniques since multiple signals (i.e. label probes) are bound to a single target, resulting in the amplification of the signal. Sandwich assays are used when the target sequence does not comprise a label; that is, when a secondary probe, comprising labels, is used to generate the signal.

As discussed herein, it should be noted that the sandwich assays can be used for the detection of primary target sequences (e.g. from a patient sample), or as a method to detect the product of an amplification reaction as outlined above; thus for example, any of the newly synthesized strands outlined above, for example using PCR, LCR, NASBA, SDA, etc., may be used as the “target sequence” in a sandwich assay.

In a preferred embodiment, the detection surface comprises at least one detection electrode. The capture probe is covalently attached to the electrode, via an “attachment linker”, using a variety of techniques. By “covalently attached” herein is meant that two moieties are attached by at least one bond, including sigma bonds, pi bonds and coordination bonds. Preferred methods utilize conductive polymers or insulators as is generally described in WO 98/20162 and WO 99/57317, both of which are hereby expressly incorporated herein by reference in their entirety.

In a preferred embodiment, the detection surface comprises at least one detection electrode comprising a self-assembled monolayer. As outlined herein, the efficiency of target analyte binding (for example, oligonucleotide hybridization) may increase when the analyte is at a distance from the detection electrode. Similarly, non-specific binding of biomolecules, including the target analytes, to a detection electrode is generally reduced when a monolayer is present. Thus, a monolayer facilitates the maintenance of the analyte away from the electrode surface. In addition, a monolayer serves to keep charged species away from the surface of the electrode. Thus, this layer helps to prevent electrical contact between the electrodes and the ETMs, or between the electrode and charged species within the solvent. Such contact can result in a direct “short circuit” or an indirect short circuit via charged species which may be present in the sample. Accordingly, the monolayer is preferably tightly packed in a uniform layer on the electrode surface, such that a minimum of “holes” exist. The monolayer thus serves as a physical barrier to block solvent accessability to the detection electrode.

The terms “electron donor moiety”, “electron acceptor moiety”, and “ETMs” (ETMs) or grammatical equivalents herein refers to molecules capable of electron transfer under certain conditions. It is to be understood that electron donor and acceptor capabilities are relative; that is, a molecule which can lose an electron under certain experimental conditions will be able to accept an electron under different experimental conditions. It is to be understood that the number of possible electron donor moieties and electron acceptor moieties is very large, and that one skilled in the art of electron transfer compounds will be able to utilize a number of compounds in the present invention. Preferred ETMs include, but are not limited to, transition metal complexes, organic ETMs, and electrodes.

In a preferred embodiment, the ETMs are transition metal complexes. Transition metals are those whose atoms have a partial or complete d shell of electrons. Suitable transition metals for use in the invention include, but are not limited to, cadmium (Cd), copper (Cu), cobalt (Co), palladium (Pd), zinc (Zn), iron (Fe), ruthenium (Ru), rhodium (Rh), osmium (Os), rhenium (Re), platinum (Pt), scandium (Sc), titanium (Ti), Vanadium (V), chromium (Cr), manganese (Mn), nickel (Ni), Molybdenum (Mo), technetium (Tc), tungsten (W), and iridium (Ir). That is, the first series of transition metals, the platinum metals (Ru, Rh, Pd, Os, Ir and Pt), along with Fe, Re, W, Mo and Tc, are preferred. Particularly preferred are ruthenium, rhenium, osmium, platinum, cobalt and iron.

The transition metals are complexed with a variety of ligands, L, to form suitable transition metal complexes, as is well known in the art. L are the co-ligands, that provide the coordination atoms for the binding of the metal ion. As will be appreciated by those in the art, the number and nature of the co-ligands will depend on the coordination number of the metal ion. Mono-, di- or polydentate co-ligands may be used at any position. Thus, for example, when the metal has a coordination number of six, the L from the terminus of the conductive oligomer, the L contributed from the nucleic acid, and r, add up to six. Thus, when the metal has a coordination number of six, r may range from zero (when all coordination atoms are provided by the other two ligands) to four, when all the co-ligands are monodentate. Thus generally, r will be from 0 to 8, depending on the coordination number of the metal ion and the choice of the other ligands.

In one embodiment, the metal ion has a coordination number of six and both the ligand attached to the conductive oligomer and the ligand attached to the nucleic acid are at least bidentate; that is, r is preferably zero, one (i.e. the remaining co-ligand is bidentate) or two (two monodentate co-ligands are used).

As will be appreciated in the art, the co-ligands can be the same or different. Suitable ligands fall into two categories: ligands which use nitrogen, oxygen, sulfur, carbon or phosphorus atoms (depending on the metal ion) as the coordination atoms (generally referred to in the literature as sigma (O) donors) and organometallic ligands such as metallocene ligands (generally referred to in the literature as pi (n) donors, and depicted herein as Lₘ). Suitable nitrogen donating ligands are well known in the art and include, but are not limited to, NH₂; NHR; NRR′; pyridine; pyrazine; isonicotinamide; imidazole; bipyridine and substituted derivatives of bipyridine; terpyridine and substituted derivatives; phenanthrolines, particularly 1,10-phenanthroline (abbreviated phen) and substituted derivatives of phenanthrolines such as 4,7-dimethylphenanthroline and dipyridol[3,2-a:2′,3′-c]phenazine (abbreviated dppz); dipyridophenazine; 1,4,5,8,9,12-hexaazatriphenylene (abbreviated hat); 9,10-phenanthrenequinone diimine (abbreviated phi); 1,4,5,8-tetraazaphenanthrene (abbreviated tap); 1,4,8,11-tetra-azacyclotetradecane (abbreviated cyclam), EDTA, EGTA and isocyanide. Substituted derivatives, including fused derivatives, may also be used. In some embodiments, porphyrins and substituted derivatives of the porphyrin family may be used. See for example, Comprehensive Coordination Chemistry, Ed. Wilkinson et al., Pergammon Press, 1987, Chapters 13.2 (pp73-98), 21.1 (pp. 813-898) and 21.3 (pp 915-957), all of which are hereby expressly incorporated by reference.

Suitable sigma donating ligands using carbon, oxygen, sulfur and phosphorus are known in the art. For example, suitable sigma carbon donors are found in Cotton and Wilkenson, Advanced Organic Chemistry, 5th Edition, John Wiley & Sons, 1988, hereby incorporated by reference; see page 38, for example. Similarly, suitable oxygen ligands include crown ethers, water and others known in the art. Phosphines and substituted phosphines are also suitable; see page 38 of Cotton and Wilkenson.

The oxygen, sulfur, phosphorus and nitrogen-donating ligands are attached in such a manner as to allow the heteroatoms to serve as coordination atoms.

In a preferred embodiment, organometallic ligands are used. In addition to purely organic compounds for use as redox moieties, and various transition metal coordination complexes with δ-bonded organic ligand with donor atoms as heterocyclic or exocyclic substituents, there is available a wide variety of transition metal organometallic compounds with n-bonded organic ligands (see Advanced Inorganic Chemistry, 5th Ed., Cotton & Wilkinson, John Wiley & Sons, 1988, chapter 26; Organometallics, A Concise Introduction, Elschenbroich et al., 2nd Ed., 1992, VCH; and Comprehensive Organometallic Chemistry II, A Review of the Literature 1982-1994, Abel et al. Ed., Vol. 7, chapters 7, 8, 10 & 11, Pergamon Press, hereby expressly incorporated by reference). Such organometallic ligands include cyclic aromatic compounds such as the cyclopentadienide ion [C₅H₅(−1)] and various ring substituted and ring fused derivatives, such as the indenylide (−1) ion, that yield a class of bis(cyclopentadieyl) metal compounds, (i.e. the metallocenes); see for example Robins et al., J. Am. Chem. Soc. 104:1882-1893 (1982); and Gassman et al., J. Am. Chem. Soc. 108:4228-4229 (1986), incorporated by reference. Of these, ferrocene [(C₅H₅)₂Fe] and its derivatives are prototypical examples which have been used in a wide variety of chemical (Connelly et al., Chem. Rev. 96:877-910 (1996), incorporated by reference) and electrochemical (Geiger et al., Advances in Organometallic Chemistry 23:1-93; and Geiger et al., Advances in Organometallic Chemistry 24:87, incorporated by reference) electron transfer or “redox” reactions. Metallocene derivatives of a variety of the first, second and third row transition metals are potential candidates as redox moieties that are covalently attached to either the ribose ring or the nucleoside base of nucleic acid. Other potentially suitable organometallic ligands include cyclic arenes such as benzene, to yield bis(arene)metal compounds and their ring substituted and ring fused derivatives, of which bis(benzene)chromium is a prototypical example, Other acyclic n-bonded ligands such as the allyl(−1) ion, or butadiene yield potentially suitable organometallic compounds, and all such ligands, in conjuction with other n-bonded and δ-bonded ligands constitute the general class of organometallic compounds in which there is a metal to carbon bond. Electrochemical studies of various dimers and oligomers of such compounds with bridging organic ligands, and additional non-bridging ligands, as well as with and without metal-metal bonds are potential candidate redox moieties in nucleic acid analysis.

When one or more of the co-ligands is an organometallic ligand, the ligand is generally attached via one of the carbon atoms of the organometallic ligand, although attachment may be via other atoms for heterocyclic ligands. Preferred organometallic ligands include metallocene ligands, including substituted derivatives and the metalloceneophanes (see page 1174 of Cotton and Wilkenson, supra). For example, derivatives of metallocene ligands such as methylcyclopentadienyl, with multiple methyl groups being preferred, such as pentamethylcyclopentadienyl, can be used to increase the stability of the metallocene. In a preferred embodiment, only one of the two metallocene ligands of a metallocene are derivatized.

As described herein, any combination of ligands may be used. Preferred combinations include: a) all ligands are nitrogen donating ligands; b) all ligands are organometallic ligands; and c) the ligand at the terminus of the conductive oligomer is a metallocene ligand and the ligand provided by the nucleic acid is a nitrogen donating ligand, with the other ligands, if needed, are either nitrogen donating ligands or metallocene ligands, or a mixture.

In addition to transition metal complexes, other organic electron donors and acceptors may be covalently attached to the nucleic acid for use in the invention. These organic molecules include, but are not limited to, riboflavin, xanthene dyes, azine dyes, acridine orange, N,N′-dimethyl-2,7-diazapyrenium dichloride (DAP²⁺), methylviologen, ethidium bromide, quinones such as N,N′-dimethylanthra(2,1,9-def:6,5,10-d′e′f′)diisoquinoline dichloride (ADIQ²+); porphyrins ([meso-tetrakis(-methyl-x-pyridinium)porphyrin tetrachloride], varlamine blue B hydrochloride, Bindschedler's green; 2,6-dichloroindophenol, 2,6-dibromophenolindophenol; Brilliant crest blue (3-amino-9-dimethylamino-10-methylphenoxyazine chloride), methylene blue; Nile blue A (aminoaphthodiethylaminophenoxazine sulfate), indigo-5,5′,7,7′-tetrasulfonic acid, indigo-5,5′,7-trisulfonic acid; phenosafranine, indigo-5-monosulfonic acid; safranine T; bis(dimethylglyoximato)-iron(II) chloride; induline scarlet, neutral red, anthracene, coronene, pyrene, 9-phenylanthracene, rubrene, binaphthyl, DPA, phenothiazene, fluoranthene, phenanthrene, chrysene, 1,8-diphenyl-1,3,5,7-octatetracene, naphthalene, acenaphthalene, perylene, TMPD and analogs and subsitituted derivatives of these compounds.

The choice of the specific ETMs will be influenced by the type of electron transfer detection used, as is generally outlined below. Preferred ETMs are metallocenes, with ferrocene being particularly preferred.

In a preferred embodiment, a plurality of ETMs are used.

The ETMs are attached to nucleic acids, target analytes, or soluble binding ligands as is generally outlined in WO 98/20162, hereby expressly incorporated by reference in its entirety.

Detection of electron transfer is generally initiated electronically, with voltage being preferred. A potential is applied to the assay complex. Precise control and variations in the applied potential can be via a potentiostat and either a three electrode system (one reference, one sample (or working) and one counter electrode) or a two electrode system (one sample and one counter electrode). This allows matching of applied potential to peak potential of the system which depends in part on the choice of ETMs (when reporters are used) and in part on the, other system components, the composition and integrity of the monolayer, and what type of reference electrode is used. As described herein, ferrocene is a preferred ETM

In some embodiments, co-reductants or co-oxidants are used as is generally described in WO00/16089, hereby expressly incorporated by reference.

In one embodiment, the efficient transfer of electrons from the ETM to the electrode results in stereotyped changes in the redox state of the ETM. With many ETMs including the complexes of ruthenium containing bipyridine, pyridine and imidazole rings, these changes in redox state are associated with changes in spectral properties. Significant differences in absorbance are observed between reduced and oxidized states for these molecules. See for example Fabbrizzi et al., Chem. Soc. Rev. 1995 pp197-202). These differences can be monitored using a spectrophotometer or simple photomultiplier tube device.

In this embodiment, possible electron donors and acceptors include all the derivatives listed above for photoactivation or initiation. Preferred electron donors and acceptors have characteristically large spectral changes upon oxidation and reduction resulting in highly sensitive monitoring of electron transfer. Such examples include Ru(NH₃)₄py and Ru(bpy)₂im as preferred examples. It should be understood that only the donor or acceptor that is being monitored by absorbance need have ideal spectral characteristics.

In a preferred embodiment, the electron transfer is detected fluorometrically. Numerous transition metal complexes, including those of ruthenium, have distinct fluorescence properties. Therefore, the change in redox state of the electron donors and electron acceptors attached to the nucleic acid can be monitored very sensitively using fluorescence, for example with Ru(4,7-biphenyl₂-phenanthroline)₃²⁺. The production of this compound can be easily measured using standard fluorescence assay techniques. For example, laser induced fluorescence can be recorded in a standard single cell fluorimeter, a flow through “on-line” fluorimeter (such as those attached to a chromatography system) or a multi-sample “plate-reader” similar to those marketed for 96-well immuno assays.

In a further embodiment, electrochemiluminescence is used as the basis of the electron transfer detection. With some ETMs such as Ru²⁺(bpy)₃, direct luminescence accompanies excited state decay. Changes in this property are associated with nucleic acid hybridization and can be monitored with a simple photomultiplier tube arrangement (see Blackburn, G. F. Clin. Chem. 37: 1534-1539 (1991); and Juris et al., supra.

In a preferred embodiment, electronic detection is used, including amperommetry, voltammetry, capacitance, and impedance. Suitable techniques include, but are not limited to, electrogravimetry; coulometry (including controlled potential coulometry and constant current coulometry); voltametry (cyclic voltametry, pulse voltametry (normal pulse voltametry, square wave voltametry, differential pulse voltametry, Osteryoung square wave voltametry, and coulostatic pulse techniques); stripping analysis (aniodic stripping analysis, cathiodic stripping analysis, square wave stripping voltammetry); conductance measurements (electrolytic conductance, direct analysis); time-dependent electrochemical analyses (chronoamperometry, chronopotentiometry, cyclic chronopotentiometry and amperometry, AC polography, chronogalvametry, and chronocoulometry); AC impedance measurement; capacitance measurement; AC voltametry; and photoelectrochemistry.

In a preferred embodiment, monitoring electron transfer is via amperometric detection. This method of detection involves applying a potential (as compared to a separate reference electrode) between the nucleic acid-conjugated electrode and a reference (counter) electrode in the sample containing target genes of interest. Electron transfer of differing efficiencies is induced in samples in the presence or absence of target analyte; that is, the presence or absence of the target analyte, and thus the label probe, can result in different currents.

The device for measuring electron transfer amperometrically involves sensitive current detection and includes a means of controlling the voltage potential, usually a potentiostat. This voltage is optimized with reference to the potential of the electron donating complex on the label probe. Possible electron donating complexes include those previously mentioned with complexes of iron, osmium, platinum, cobalt, rhenium and ruthenium being preferred and complexes of iron being most preferred.

In a preferred embodiment, alternative electron detection modes are utilized. For example, potentiometric (or voltammetric) measurements involve non-faradaic (no net current flow) processes and are utilized traditionally in pH and other ion detectors. Similar sensors are used to monitor electron transfer between the ETM and the electrode. In addition, other properties of insulators (such as resistance) and of conductors (such as conductivity, impedance and capicitance) could be used to monitor electron transfer between ETM and the electrode. Finally, any system that generates a current (such as electron transfer) also generates a small magnetic field, which may be monitored in some embodiments.

In a preferred embodiment, electron transfer is initiated using alternating current (AC) methods. Without being bound by theory, it appears that ETMs, bound to an electrode, generally respond similarly to an AC voltage across a circuit containing resistors and capacitors.

Alternatively, reporterless or labelless systems are used. In this embodiment, two detection electrodes are used to measure changes in capacitance or impedance as a result of target analyte binding. See generally U.S. Ser. No. 09/458,533, filed Dec. 9, 1999 and PCT US00/33497, both of which are expressly incorporated by reference.

In this embodiment, using a labelless system, the surface of the two detection electrodes is covered with a layer of polymer matrix. In these embodiments, probe molecules are attached onto a supporting matrix on the surface of the electrodes using the functional chemistry mentioned above. The polymer matrix is preferably selected to be polypyrrole, polythiophene, polyaniline, polyacrylamide, agarose gel, polyethylene glycol, cellular, sol gels, dendrimers, metallic nanoparticles, carbon nanotubes, and their copolymers. In preferred embodiments, the material comprises a neutral pyrrole matrix. To increase the probe loading capacity, porous matrix such as polyacrylamide, agarose, or sol gels are preferred.

When labels such as ETMs are not used, other initiation/detection systems may be preferred. In this embodiment, molecular interactions between immobilized probe molecules and target molecules in a sample mixture are detected by detecting an electrical signal using AC impedance. In other embodiments, such molecular interactions are detected by detecting an electrical signal using an electrical or electrochemical detection method selected from the group consisting of impedance spectroscopy, cyclic voltammetry, AC voltammetry, pulse voltammetry, square wave voltammetry, AC voltammetry, hydrodynamic modulation voltammetry, conductance, potential step method, potentiometric measurements, amperometric measurements, current step method, other steady-state or transient measurement methods, and combinations thereof.

In one embodiment of the apparatus of the present invention, the means for producing electrical impedance at each test electrode is accomplished using a Model 1260 Impedance/Gain Phase Analyzer with Model 1287 Electrochemical Interface (Solartron Inc., Houston, Tex.). Other electrical impedance measurement means include, but are not limited to, transient methods using AC signal perturbation superimposed upon a DC potential applied to an electrochemical cell such as AC bridge and AC voltammetry. The measurements can be conducted at any particular frequency that specifically produces electrical signal changes that are readily detected or otherwise determined to be advantageous. Such particular frequencies are advantageously determined by scanning frequencies to ascertain the frequency producing, for example, the largest difference in electrical signal. The means for detecting changes in impedance at each test site electrode as a result of molecular interactions between probe and target molecules can be accomplished by using any of the above-described instruments.

In a preferred embodiment, the detection module is placed at a location of maximum or minimum electric field strength within the microfluidic device. For example, in one embodiment, the detection module is placed at the physical constriction within the concentration module. In another embodiment, the detection module comprises a detection electrode, and the detection electrode itself serves as the electrically floating conductive material used to enhance the electric field strength.

Thus, the present invention provides microfluidic devices that may be configured in a wide variety of ways. For example, FIG. 2 depicts one embodiment of a device according to the present invention, device 405. In this embodiment, concentration module 408 comprises microfluidic channel 400 with a physical constriction 410. Inlet port 401 and outlet port 402 are optionally provided as shown. The channel and constriction may take substantially any form described above. Here, channel 400 is 200 μm wide and narrows at an angle to a 4 μm wide physical constriction 410. Field-generating electrodes 420 and 421 are positioned upstream and downstream of physical constriction 410. In this embodiment, electrodes 420 and 421 comprise platinum, are rectangular and are placed on the outside of device 405. However, the electrodes may generally take any shape be positioned in any manner described above. In particular, the electrodes and the concentration module are configured to result in an asymmetrical field within the concentration module upon the application of a time-varying voltage. Concentration module optionally further comprises electrically floating conductive electrode 430 at constriction point 410. Electrically floating conductive electrode 430 is preferably fabricated from gold, and may be derivitized to form a detection electrode. In other embodiments, a plurality of floating electrodes may be provided at the physical constriction. The plurality may similarly be derivitized to form detection electrodes. That is, the detection module of device 405 may comprise an electrically floating conductive electrodes, such as electrode 430, provided at said physical constriction. In those embodiments, floating electrode 430 comprises capture probes, and optionally, self-assembled monolayers, as described above.

In other embodiments, a separate detection module 440 is provided and in fluidic communication with concentration module 408, for example through an extension of channel 400 as shown in FIG. 2. Detection module 440 comprises a chamber having one or more locations comprising capture probes, as described above. Detection module 440 optionally comprises one or more detection electrodes comprising capture probes, and optionally comprising self-assembled monolayers, as described above. For simplicity, capture probes and self-assembled monolayers are not depicted in FIG. 2. Valves as described above, such as valve 450, may optionally be provided to control sample movement between modules of the device. Further pumps, as described above, may be provided on- or off-chip to generate fluid motion, and are not shown in FIG. 2 for simplicity. Thus, target analytes may be concentrated and detected at detection module 408. Alternatively, target analytes may be concentrated at detection module 408 while contaminant analytes are washed through the device and then pre-concentrated target analytes may be pumped to detection module 440. In other embodiments, contaminant analytes may be concentrated at detection module 408 while target analytes are transported to detection module 440. FIG. 2 is exemplary only, and any configuration of channels, chambers, pumps, valves, and inlet and outlet ports may be used in the practice of the invention, as described above.

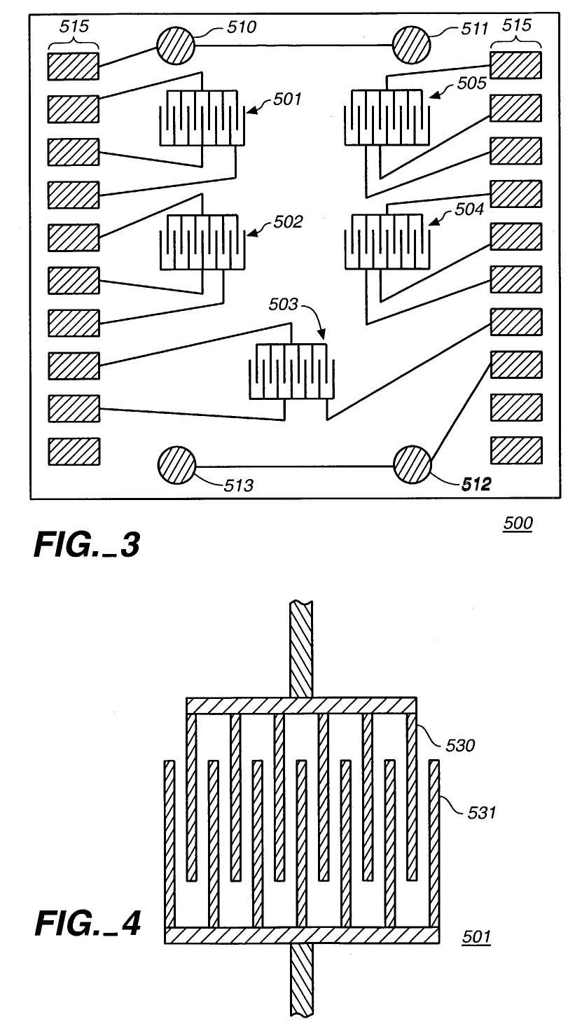

Another embodiment of a concentration module according to the present invention, concentration module 500, is depicted in FIGS. 3 and 4. FIG. 3 depicts a top-down view of the module. Module 500 is provided on a substrate, and preferably within a fluid chamber or channel, as described above. Five electrode pairs 501, 502, 503, 504, and 505 are situated between four large outer electrodes 510, 511, 512, and 513. The number of electrodes is not limited to five pairs and four outer electrodes, and is intended to be illustrative only. The electrode pairs and outer electrodes may be advantageously connected to bondpads 515, which may be placed in a standard arrangement to facilitate packaging or integration with other modules. FIG. 4 depicts a detailed view of one of the five electrode pairs, electrode pair 501. The electrode pairs consist of two electrodes, 530 and 531, having interdigitating fingers with 2 μm line and spacings. One of these interdigitated electrodes (per pair) functions as an electrophoretic/dielectrophoretic electrode, 530, and the other acts as a floating electrode, 531. In a preferred embodiment, concentration module 501 is also a detection module, and floating electrode 531 comprises capture probes and optionally a self assembled monolayer. In a preferred embodiment, the dielectrophoretic/electrophorectic electrode 530 is fabricated from platinum, while the detection electrode 531 is fabricated from gold. A DC voltage may be applied between outer electrodes 510, 511, 512, and 513 and inner dielectrophoretic/electrophoretic electrodes, such as electrode 531. Target analytes are then transported to the dielectrophoretic/electrophoretic electrodes, such as electrode 531. Subsequently, an AC voltage, or other time-varying voltage, may be applied between fingers of electrode 5531, and fingers of floating electrode 532 allowed to float. This allows for the concentration of target analytes at floating electrode 532 (away from a powered electrode).

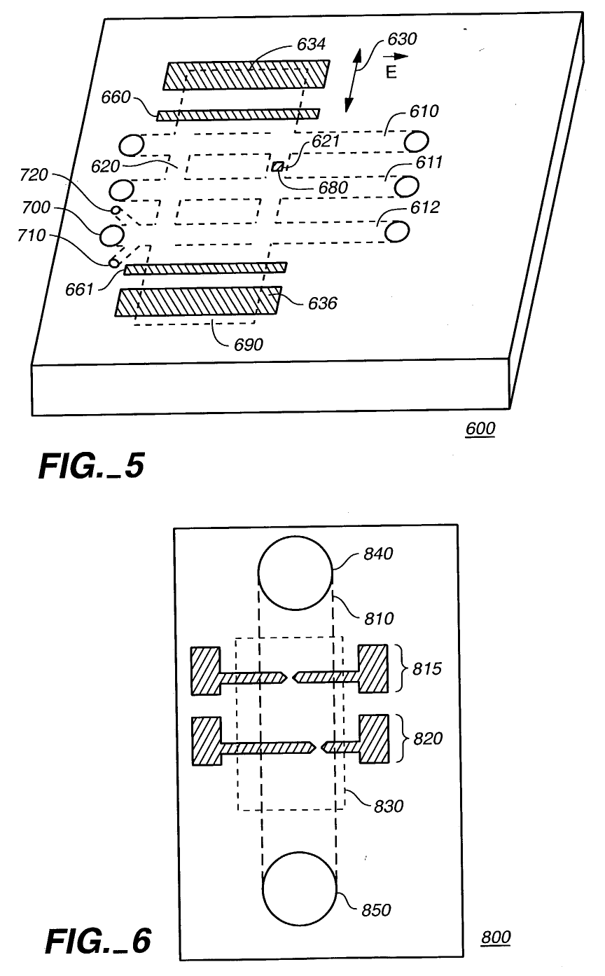

FIG. 5 depicts an embodiment of the present invention, device 600, that find particular application to performing DNA amplification. One or more flow channels, such as channel 610, 611, and 612 in FIG. 5 are fabricated perpendicular to the direction of applied electric field 630 (for example, field generating electrodes 634 and 636 may be used). Alternatively, interdigitated field-generating electrodes may be provided such that one finger lies between each channel—610, 611, and 612. Constriction points, such as constriction point 620 and 621 are formed as gaps in channel walls. They may be rectangular gaps as shown, or substantially any other shape constriction, as described above. Further, as described above, one or more floating electrodes, generally represented by electrode 680, may be placed at any of the physical constrictions to further concentrate the field there. The floating electrodes may or may not be configured as detection electrodes comprising capture probes and optionally SAMs, as discussed above. That is, a detection module may be located at constrictions such as constriction 620 or 621. Heaters, coolers, and/or temperature sensors are provided such as embedded sensors 660 and 661 for preferably thermal cycling of the device. Temperature sensors are described above. In other embodiments, a detection module is in fluidic communication with the concentration module, represented by constrictions 620 and 621 in FIG. 5. For example, a detection module may be located generally in area 690, and pre-concentrated analytes transported there.

The present invention provides methods for detecting target analytes in a sample comprising contacting a concentration module with the sample. By ‘contacting’ herein is meant placing the sample within the concentration module, discussed above, such that analytes in the sample can be subjected to an asymmetrical, oscillating electric field, as discussed above. Sample can be introduced to the concentration module manually, by inserting a pipette through an appropriate inlet port in the concentration module, or otherwise dispensing sample into the module, as known in the art. Sample may also be pumped into the concentration module from another module or reservoir, as is known in the art.

The present invention provides methods for detecting target analytes in a sample comprising applying a time-varying voltage between at least two field-generating electrodes of a concentration module sufficient to generate an asymmetrical electric field, thereby manipulating polarizable analytes in the sample via dielectrophoresis. By “manipulating” herein is meant subjecting polarizable analytes to a dielectrophoresis force to influence motion of the analytes. “Manipulating”, therefore, may take the form of rotating, sorting, filtering, directing, concentrating, trapping, or transporting. In one embodiment, polarizable analytes are sorted or filtered based on their response to a dielectrophoresis force.

In preferred embodiments, ‘manipulating’ refers to concentrating or trapping. ‘Concentrating’ refers to moving polarizable analytes to a particular region, such that the concentration of analytes in this region is greater than the concentration in the sample prior to concentrating. ‘Trapping’ refers to moving polarizable analytes to a particular region such that they are held in that region, even in the presence of other forces. In one embodiment, polarizable analytes and concentrated at a physical constriction in the concentration module and trapped there as other fluids are pumped through the module. That is, the dielectrophoresis force holding the polarizable analytes at the constriction point is greater than the hydrodynamic force of the fluid.

The present invention provides methods for detecting target analytes comprising transporting target analytes to a detection module. By ‘transporting’ herein is meant moving target analytes from one location to the detection module. In a preferred embodiment, target analytes are transported to a detection module via dielectrophoresis. In other embodiments, target analytes are transported to a detection module by pumping the sample containing the target analytes to the detection module, or by agitating the sample with pumps or other agitation devices.

Target analytes are accordingly transported to a detection module under conditions sufficient for detection to occur. These conditions will vary according to the particular target analyte and capture probe in question. Generally, however, by ‘under conditions sufficient for detection to occur’ herein is meant that the temperature of the device and sample is such that binding between the target analyte and capture probe may occur. Further, the rate at which sample is passed over the detection module, or the time at which sample is held in the detection module, is sufficient to allow binding between the target analyte and capture probe.

Accordingly, embodiments of the present invention provide methods of concentrating target analytes at a detection module. Generally, these methods involve placing the detection module at an area of maximum or minimum electric field within the concentration module. Applying a time-varying potential between field-generating electrodes thereby transports target analytes to the detection module.

In other embodiments, target analytes are concentrated within a concentration module and subsequently pumped to a detection module.

In still other embodiments, contamination analytes are concentrated within a concentration module and target analytes are transported to a detection module.

In yet other embodiments, target analytes are trapped within a concentration module, and contamination analytes are washed from the concentration module.

In still other embodiments, target analytes are trapped within a concentration module and an agent is applied to the concentration module. This agent may be, for example, a lysing agent or amplification agent. These include reagents like salts, buffers, neutral proteins, e.g. albumin, detergents, etc which may be used to facilitate optimal hybridization and detection, and/or reduce non-specific or background interactions. Also reagents that otherwise improve the efficiency of the assay, such as protease inhibitors, nuclease inhibitors, anti-microbial agents, etc., may be used, depending on the sample preparation methods and purity of the target.

The present invention further provides methods for detecting multiple target analytes at multiple detection modules. For example, after completing one of the above methods for transporting target analytes to a detection module, the voltage between field-generating electrodes may be turned off, removing the oscillating, asymmetrical electric field. The sample may then be agitated, through a series of pumps or other techniques as known in the art, to release or recirculate remaining analytes in the sample. Applying a time-varying voltage again generates a second oscillating, asymmetrical electric field and target analytes may be transported to a second detection module.

In a preferred embodiment, target analytes are concentrated on one field-generating electrode via electrophoresis. That is, a DC, or non-time varying voltage, is applied between two field-generating electrodes. Subsequently, the target analytes are directed toward an unpowered detection electrode via dielectrophoresis.

The present invention allows for separation of target analytes based on their dielectrophoresis response. Substantially any target analytes may be separated based on permittivity or their changing dielectrophoresis response with frequency. In one embodiment, longer DNA fragments may be separated from smaller DNA fragments.

Particular embodiments of methods provided by the present invention will vary according to the device used, and the application. Several examples are described below.

Referring to FIG. 2, sample containing target analyte is introduced to channel 400 through an inlet port such as port 401. A time-varying voltage is applied between field-generating electrodes 420 and 421, by a power source (not shown), generating an electric field within channel 400 having a field maxima at constriction point 430. The magnitude and frequency of the time-varying voltage is chosen such that the target analyte is concentrated within constriction point 430. During concentration, the sample may be agitated or pumped through the constriction point, allowing for a larger portion of the sample to be concentrated. An on- or off-chip pump (not shown) may accomplish this sample circulation. In another embodiment, after concentration of target analyte at constriction point 430, the power source is turned off, and the concentrated sample is pumped to a detection area, such as area 440. In another embodiment, the magnitude and frequency of the time-varying voltage is chosen such that contamination analytes are concentrated within constriction point 430. The time-varying voltage remains on to trap contamination analytes at constriction point 430 as containing target analyte is pumped or recirculated to a detection module, such as area 440.

The field strength, applied waveform frequency, or angle of the channel near the constriction point can be chosen to select a desired target analyte. For example, large DNA targets could be concentrated preferentially to smaller fragments. One or more constriction points 430 may be placed in series, allowing target analyte to be separated or filtered by dielectrophoresis response or size. Trapping efficiency is also influenced by the ratio of constriction size to channel width.

Referring now to FIG. 3, a sample is applied to the device, and a DC voltage is applied between the four outer electrodes 510, 511, 512, and 513 (cathode) and the inner interdigitated dielectrophoretic/electrophoretic platinum electrodes of groups 501, 502, 503, 504 (anode). Alternatively, the outer electrodes could serve as the anode, and the platinum electrodes as the cathode. In a preferred embodiment, the anodes may be covered with a permeation layer that allows small anions to pass, but excludes the passage of large anions (such as the target analyte). The target analyte, for example, DNA is concentrated at the platinum interdigitated electrodes via electrophoresis. Referring to FIG. 4, following electrophoretic concentration, the DC bias is turned off and an AC bias is applied between the interdigitated platinum fingers 531. In some embodiments, it may be desirable for a DC offset to remain while the AC bias is applied. The gold fingers 530 are allowed to float, and concentrate the generated electric field at their surfaces. Such a configuration dielectrophoretically transports the DNA to the gold fingers 530. In some embodiments, gold fingers 530 are configured as a detection module, comprising capture probes and optionally SAMs, as discussed above. In other embodiments, buffer solution is washed through or over chip 500 as target analytes are trapped at fingers 530. Thereafter, pre-concentrated target analytes are transported to a detection module (not shown).

Other embodiments may similarly be utilized to perform a combination of electrophoresis to transport target analytes to a known location of an electrode and dielectrophoresis to transport the analytes to an unpowered detection electrode.

Referring to FIG. 5, briefly, cells are introduced to channel 610, 611, or 612 through fluid inlet, such as inlet 700. An oscillating electric field is generated within the device through field-generating electrodes, such as field-generating electrodes 634 and 636. In another embodiment, interdigitated field-generating electrodes are provided between each of the channels. The application of an oscillating electric field results in trapping cells at the constriction points, perpendicular to fluid flow, such as constriction points 620 and 621. Lysing agent can then be introduced through a fluid inlet, such as inlet 710, resulting in cell lysing. In another embodiment, cell lysing is accomplished by heating the device, or by a pressure force exerted on the cells, as discussed above. DNA released from the cells is then trapped in a constriction point by the application of an oscillating electric field. Amplification agents are then introduced to through fluid inlet, such as inlet 720. In another embodiment, sample, lysing agent, and amplification agents are introduced sequentially through the same inlet. Amplification is achieved by thermal cycling with the heater and temperature-monitoring sensor, generally represented by embedded resistive heaters 660 and 661 beneath the channels.

In another embodiment, programmable constriction points are provided. FIG. 6 schematically depicts a concentration module having programmable constriction points. Generally, the microfluidic device 800 comprises a channel 810 supported by a substrate comprising one or more magnetic structures, such as structures 815 and 820 atop electromagnet 830. A top-down view is shown here for simplicity. Magnetorheological fluid is introduced to the channel through input port 840. The desired magnetic circuit is magnetized, for example circuit 815 to address the appropriate constriction location. In the energized region, the fluid solidifies. Remaining MR fluid is flushed from the channel, through output port 850 leaving the desired channel constriction point in place. As described above, sample fluid can then be introduced to the channel and target analyte can then be concentrated at this constriction point. For simplicity, field-generating electrodes and a detection module is not shown in this figure, although it will be apparent to those skilled in the art how those features could readily be combined with the programmable constriction concentration module shown in FIG. 6.

We claim:

1. A microfluidic device for manipulating polarizable analytes via dielectrophoresis and detecting target analytes, said device comprising:
a) a concentration module in electronic communication with a field-generating electrode, wherein said concentration module is configured to result in an asymmetrical, oscillating electric field within said module upon application of a time-varying voltage;
b) at least one detection module comprising capture probes; and
c) a power source.

2. A microfluidic device according to claim 1 wherein said concentration module comprises at least one physical constriction to allow the generation of said asymmetrical field.

3. A microfluidic device according to claim 2 wherein said detection module is placed at said physical constriction.

4. A microfluidic device according to claim 3 wherein said detection module comprises at least one detection electrode comprising said capture probes.

5. A microfluidic device according to claim 2 further comprising an electrically floating conductive material at said constriction.

6. A microfluidic device according to claim 4 wherein said detection module comprises an array of detection electrodes each comprising a capture probe.

7. A microfluidic device according to claim 6 wherein said detection electrodes further comprise a self-assembled monolayer.

8. A method for detecting target analytes in a sample using a microfluidic device comprising a concentration module in electronic communication with at least two field-generating electrodes, said method comprising:
contacting said concentration module with said sample;
applying a time-varying voltage between said at least two field-generating electrodes sufficient to generate an asymmetrical electric field within said concentration module, thereby manipulating polarizable analytes in said sample via dielectrophoresis; and
transporting target analytes to said detection module under conditions sufficient for detection to occur.

9. The method of claim 8, wherein said manipulating comprises concentrating target analytes at said detection module, and wherein said manipulating and said transporting occur substantially simultaneously.

10. The method of claim 8, wherein said manipulating comprises concentrating target analytes and said transporting comprises pumping said sample containing said concentrated target analytes to said detection module.

11. The method of claim 8, wherein said manipulating comprises concentrating and trapping contamination analytes and said transporting comprises pumping said sample containing said target analytes to said detection module.

12. The method of claim 8, wherein said manipulating comprises concentrating and trapping target analytes and said method further comprises:
washing contamination analytes from said concentration module; and wherein said transporting comprises pumping said target analytes to said detection module.

13. The method of claim 8, wherein said manipulating comprises trapping target analytes and said method further comprises:
applying an agent to said concentration module containing said trapped target analytes.

14. The method of claim 13, wherein said agent is a lysing agent.

15. The method of claim 13, wherein said agent is an amplification agent.

16. The method of claim 8, wherein said method further comprises
removing said voltage between said at least two field-generating electrodes;
agitating said sample;
applying a time-varying voltage between said at least two field-generating electrodes sufficient to generate an asymmetric electric field within said concentration module, thereby manipulating polarizable analytes in said sample via dielectrophoresis; and
transporting said target analytes to a second detection module.
